(19) United States
(12) Patent Application Publication
(10) Pub. No.: US 2009/0117964 A1
(43) Pub. Date: May 7, 2009

(54) ROULETTE GAME APPARATUS AND CONTROL METHOD THEREOF

(75) Inventor: Nakayasu Tsukahara, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/038,639

(22) Filed: Feb. 27, 2008

Related U.S. Application Data
(60) Provisional application No. 60/984,625, filed on Nov. 1, 2007.

(51) Int. Cl. A63F 13/00

(52) U.S. Cl. 463/17

(57) ABSTRACT

A game apparatus according to the present invention comprises: a circular roulette wheel; a plurality of pockets arranged adjacent to one another in a line in a circumferential direction on the roulette wheel, each of the pockets associated with a number in advance; an arrangement data storage memory for storing arrangement data indicating a sequence of the plurality of the pockets on the roulette wheel; a main BET button for inputting a BET on a number associated with a single pocket out of the plurality of the pockets; a sub BET button for inputting a BET on a number associated with an adjacent pocket adjacent to the single pocket, or on numbers associated with a plurality of the respective pockets arranged adjacent to one another including the adjacent pocket; and a controller, the controller programmed to conduct the processing of (a) receiving a BET on a number associated with a single pocket out of the plurality of said pockets, based on an input from the main BET button, (b) receiving, based on an input from the sub BET button and the arrangement data stored in the arrangement data storage memory, a BET on a number associated with an adjacent pocket adjacent to the single pocket, or on numbers associated with a plurality of the respective pockets arranged adjacent to one another including the adjacent pocket, (c) controlling rotation of the roulette wheel and launching of a ball to be housed in any one of the pockets, (d) determining a number associated with one of the pockets with the ball housed therein as a winning number, and (e) providing an award, based on the winning number determined in the processing (d) and the BETs respectively inputted from the main BET button and the sub BET button.

### CROSS-REFERENCE TO RELATED APPLICATIONS

This application claims benefit of priority based on U.S. Provisional Patent Application No. 60/984,625 filed on Nov. 1, 2007. The contents of this application are incorporated herein by reference in their entirety.

### BACKGROUND OF THE INVENTION

1. Field of the Invention

The present invention relates to a roulette game apparatus and a control method thereof.

2. Discussion of the Background

Conventionally, there have been various betting methods such as straight BET, corner BET, split BET and the like. In each of these methods, a player predicts a pocket into which a ball is to be housed, out of a plurality of pockets provided on a roulette wheel and associated with respective numbers, and places a BET on a number associated with the predicted pocket. In recent years, there have been various innovations to facilitate prediction of a winning number and above-described operations of BETs. For example, a roulette game apparatus in which a player can predict a winning number by referring to a history of past game results is disclosed in US 2006/0094493-A1.

In a roulette game, in the case where a ball having been launched onto a roulette wheel does not land in a pocket that the player has predicted and placed a BET on (in the case where the player has made a wrong prediction), the player feels frustrated if a pocket with the ball housed therein is near the pocket that the player has predicted (e.g., the adjacent pocket of the pocket that the player has predicted). It is no surprise that the player desires to place a BET not only on a pocket in which the player has predicted that the ball would land, but also on the neighboring pockets (e.g., a pocket on the both sides) in order to avoid such a situation.

However, the sequence of the pockets on the roulette wheel used in the roulette game (the sequence of the numbers corresponding to the pockets on the roulette wheel) is usually different from the sequence of the numbers (descending order of the numbers) on the betting board. Hence, the player, who desires to place a BET on numbers associated with a plurality of pockets adjacent to one another, has been required to previously memorize the sequence of the numbers on the roulette wheel in the conventional roulette game apparatus. However, very few players have memorized the sequence of the numbers on the roulette wheel, and it is not easy to memorize all the sequence of the numbers. Thus, there has been a problem that placing a BET on numbers associated with a plurality of pockets adjacent to one another, such as a BET on the numbers associated with the adjacent pockets of the predicted pocket, has been difficult for many players.

The present invention has been completed considering the above-described problem, to provide a roulette game apparatus and a control method thereof which facilitate placing of a BET on numbers associated with a plurality of pockets adjacent to one another.

The contents of US 2006/0094493-A1 are incorporated herein by reference in their entirety.

### SUMMARY OF THE INVENTION

A first aspect of the present invention provides a game apparatus having the following structure.

That is, the game apparatus according to the first aspect of the present invention is a game apparatus comprising: a circular roulette wheel; a plurality of pockets arranged adjacent to one another in a line in a circumferential direction on the roulette wheel, each of the pockets associated with a number in advance; an arrangement data storage memory for storing arrangement data indicating a sequence of the plurality of the pockets on the roulette wheel; a main BET button for inputting a BET on a number associated with a single pocket out of the plurality of the pockets; a sub BET button for inputting a BET on a number associated with an adjacent pocket adjacent to the single pocket, or on numbers associated with a plurality of the respective pockets arranged adjacent to one another including the adjacent pocket; and a controller. The controller is programmed to conduct the processing of (a) receiving a BET on a number associated with a single pocket out of the plurality of the pockets, based on an input from the main BET button, (b) receiving, based on an input from the sub BET button and the arrangement data stored in the arrangement data storage memory, a BET on a number associated with an adjacent pocket adjacent to the single pocket, or on numbers associated with a plurality of the respective pockets arranged adjacent to one another including the adjacent pocket, (c) controlling rotation of the roulette wheel and launching of a ball to be housed in any one of the pockets, (d) determining a number associated with one of the pockets with the ball housed therein as a winning number, and (e) providing an award, based on the winning number determined in the processing (d) and the BETs respectively inputted from the main BET button and the sub BET button.

According to the above-mentioned game apparatus, a BET is received on a number associated with a single pocket on the roulette wheel based on an input from the main BET button, and a BET is received on numbers associated with a plurality of respective pockets arranged adjacent to one another including the adjacent pocket (for example, the adjacent pocket and the pocket adjacent to the adjacent pocket) based on the input from the sub BET button and the arrangement data indicating the sequence of the plurality of pockets on the roulette wheel.

Therefore, the player can place, by operating the main BET button, a BET on the number associated with the pocket into which the ball is predicted to be housed, and place, by operating the sub BET button, on the numbers associated with the pockets near the predicted pocket, such as a pocket adjacent to the predicted pocket and a pocket next to the adjacent pocket. In the above-mentioned game apparatus, since a BET on the numbers associated with the pockets near the predicted pocket is received based on the arrangement data, the player is not required to memorize the sequence of the numbers associated with the pockets on the roulette wheel. Thus, the player can easily place a BET on the numbers associated with the pockets near the predicted pocket. As a result, it becomes easier for the player to place a BET such that the player can receive an award even when the ball does not land in the predicted pocket but in a pocket nearby.

Desirably, the above-mentioned game apparatus further comprises the following structure.

That is, the processing (b) includes receiving, based on an input from the sub BET button and the arrangement data stored in the arrangement data storage memory, a BET on numbers each associated with an adjacent pocket adjacent on each side to the single pocket, or on numbers associated with a plurality of the respective pockets arranged adjacent to one another including the adjacent pockets.

According to the above-mentioned game apparatus, a BET is received on numbers each associated with an adjacent pocket on each side adjacent to the single pocket or on numbers associated with a plurality of respective pockets arranged adjacent to one another including the adjacent pockets, based on the input from the sub BET button and the arrangement data indicating the sequence of the plurality of pockets on the roulette wheel.

Accordingly, the player can place a BET on the numbers associated with pockets on both right and left sides of the predicted pocket, such as a pocket on both sides. In the above-mentioned game apparatus, since the BET on the numbers each associated with a pocket on both right and left sides of the predicted pocket is received based on the arrangement data, the player is not required to memorize the sequence of the numbers associated with the pockets on the roulette wheel. Therefore, placing a BET on the numbers each associated with the pocket on both right and left sides of the predicted pocket is facilitated. As a result, it becomes easier for the player to place a BET such that the player can receive an award even when the ball does not land in the predicted pocket but in a nearby pocket on either the right or left side.

A second aspect of the present invention provides a game apparatus having the following structure.

That is, the game apparatus according to the second aspect of the present invention is a game apparatus comprising: a circular roulette wheel; a plurality of pockets arranged adjacent to one another in a line in a circumferential direction on the roulette wheel, each of the pockets associated with a number in advance; an arrangement data storage memory for storing arrangement data indicating a sequence of the plurality of the pockets on the roulette wheel; a control data storage memory for storing control data for controlling the game apparatus so as to provide different weights on probabilities that a ball is housed in each of the pockets; a main BET button for inputting a BET on a number associated with a single pocket out of the plurality of the pockets; a sub BET button for inputting a BET on a number associated with an adjacent pocket adjacent to the single pocket, or on numbers associated with a plurality of the respective pockets arranged adjacent to one another including the adjacent pocket; and a controller. The controller is programmed to conduct the processing of (a) receiving a BET on a number associated with a single pocket out of the plurality of the pockets, based on an input from the main BET button, (b) receiving, based on an input from the sub BET button and the arrangement data stored in the arrangement data storage memory, a BET on a number associated with an adjacent pocket adjacent to the single pocket, or on numbers associated with a plurality of the respective pockets arranged adjacent to one another including the adjacent pocket, (c) controlling, based on the control data stored in the control data storage memory, rotation of the roulette wheel and launching of the ball, (d) determining a number associated with one of the pockets with the ball housed therein as a winning number, and (e) providing an award, based on the winning number determined in the processing (d) and the BETs respectively inputted from the main BET button and the sub BET button.

According to the above-mentioned game apparatus, in a state where the game apparatus is controlled to provide different weights on probabilities that the ball is housed in each of the plurality of pockets on the roulette wheel, a BET is received on a number associated with a single pocket on the roulette wheel based on an input from the main BET button, and a BET is received on numbers associated with a plurality of respective pockets arranged adjacent to one another including the adjacent pocket (for example, the adjacent pocket and the pocket adjacent to the adjacent pocket) based on the input from the sub BET button and the arrangement data indicating the sequence of the plurality of pockets on the roulette wheel.

Therefore, the player can place, by operating the main BET button, a BET on the number associated with the pocket into which the ball is predicted to be housed, and place, by operating the sub BET button, on the numbers associated with the pockets near the predicted pocket, such as a pocket adjacent to the predicted pocket and a pocket next to the adjacent pocket. In the above-mentioned game apparatus, since a BET on the numbers associated with the pockets near the predicted pocket is received based on the arrangement data, the player is not required to memorize the sequence of the numbers associated with the pockets on the roulette wheel. Thus, the player can easily place a BET on the numbers associated with the pockets near the predicted pocket. As a result, it becomes easier for the player to place a BET such that the player can receive an award even when the ball does not land in the predicted pocket but in a pocket nearby.

Further, although it is preferred that a ball drops in each of the pockets so as to be housed therein with the same probability in a roulette apparatus, the probabilities that the ball is housed in each of the pockets tend to be biased due to a variety of factors in manufacturing thereof. On the contrary, since the above-mentioned game apparatus is controlled with use of the control data so as to provide different weights on the probabilities that the ball is housed, an administrator of the game apparatus (e.g., a manager of the casino) can prevent, by appropriately changing the control data, heavy losses due to players detecting the bias. Meanwhile, since the player can easily place a BET on the neighboring pockets of the predicted pocket even though detecting the bias of probabilities is difficult, it becomes easier for the player to place a BET such that the player can receive an award even when the prediction has been wrong.

Preferably, the above-mentioned game apparatus provides the following structure.

That is, the processing (b) includes receiving, based on an input from the sub BET button and the arrangement data stored in the arrangement data storage memory, a BET on numbers each associated with an adjacent pocket adjacent on each side to the single pocket, or on numbers associated with a plurality of the respective pockets arranged adjacent to one another including the adjacent pockets.

According to the above-mentioned game apparatus, a BET is received on numbers each associated with an adjacent pocket on each side adjacent to the single pocket or on numbers associated with a plurality of respective pockets arranged adjacent to one another including the adjacent pockets, based on the input from the sub BET button and the arrangement data indicating the sequence of the plurality of pockets on the roulette wheel.

Accordingly, the player can place a BET on the numbers associated with pockets on both right and left sides of the predicted pocket, such as a pocket on both sides. In the above-mentioned game apparatus, since the BET on the numbers each associated with a pocket on both right and left sides of the predicted pocket is received based on the arrangement data, the player is not required to memorize the sequence of the numbers associated with the pockets on the roulette wheel. Therefore, placing a BET on the numbers each associated with the pocket on both right and left sides of the predicted pocket is facilitated. As a result, it becomes easier for the player to place a BET such that the player can receive an award even when the ball does not land in the predicted pocket but in a nearby pocket on either the right or left side.

A third aspect of the present invention provides a control method of a game apparatus having the following structure.

That is, the control method of the game apparatus that includes a circular roulette wheel; a plurality of pockets arranged adjacent to one another in a line in a circumferential direction on the roulette wheel, each of the pockets associated with a number in advance; an arrangement data storage memory for storing arrangement data indicating a sequence of the plurality of the pockets on the roulette wheel; a main BET button for inputting a BET on a number associated with a single pocket out of the plurality of the pockets; a sub BET button for inputting a BET on a number associated with an adjacent pocket adjacent to the single pocket, or on numbers associated with a plurality of the respective pockets arranged adjacent to one another including the adjacent pocket; and a controller, the control method of the game apparatus comprising the steps of (a) receiving a BET on a number associated with a single pocket out of the plurality of the pockets, based on an input from the main BET button, (b) receiving, based on an input from the sub BET button and the arrangement data stored in the arrangement data storage memory, a BET on a number associated with an adjacent pocket adjacent to the single pocket, or on numbers associated with a plurality of the respective pockets arranged adjacent to one another including the adjacent pocket, (c) controlling rotation of the roulette wheel and launching of a ball to be housed in any one of the pockets, (d) determining a number associated with one of the pockets with the ball housed therein as a winning number, and (e) providing an award, based on the winning number determined in the step (d) and the BETs respectively inputted from the main BET button and the sub BET button.

According to the above-mentioned control method of a game apparatus, a BET is received on a number associated with a single pocket on the roulette wheel based on an input from the main BET button, and a BET is received on numbers associated with a plurality of respective pockets arranged adjacent to one another including the adjacent pocket (for example, the adjacent pocket and the pocket adjacent to the adjacent pocket) based on the input from the sub BET button and the arrangement data indicating the sequence of the plurality of pockets on the roulette wheel.

Therefore, the player can place, by operating the main BET button, a BET on the number associated with the pocket into which the ball is predicted to be housed, and place, by operating the sub BET button, on the numbers associated with the pockets near the predicted pocket, such as a pocket adjacent to the predicted pocket and a pocket next to the adjacent pocket. In the above-mentioned control method of a game apparatus, since a BET on the numbers associated with the pockets near the predicted pocket is received based on the arrangement data, the player is not required to memorize the sequence of the numbers associated with the pockets on the roulette wheel. Thus, the player can easily place a BET on the numbers associated with the pockets near the predicted pocket. As a result, it becomes easier for the player to place a BET such that the player can receive an award even when the ball does not land in the predicted pocket but in a pocket nearby.

Preferably, the above-mentioned control method of the game machine further comprises the following structure.

That is, the step (b) includes receiving, based on an input from the sub BET button and the arrangement data stored in the arrangement data storage memory, a BET on numbers each associated with an adjacent pocket adjacent on each side to the single pocket, or on numbers associated with a plurality of the respective pockets arranged adjacent to one another including the adjacent pockets.

According to the above-mentioned control method of a game apparatus, a BET is received on numbers each associated with an adjacent pocket on each side adjacent to the single pocket or on numbers associated with a plurality of respective pockets arranged adjacent to one another including the adjacent pockets, based on the input from the sub BET button and the arrangement data indicating the sequence of the plurality of pockets on the roulette wheel.

Accordingly, the player can place a BET on the numbers associated with pockets on both right and left sides of the predicted pocket, such as a pocket on both sides. In the above-mentioned game apparatus, since the BET on the numbers each associated with a pocket on both right and left sides of the predicted pocket is received based on the arrangement data, the player is not required to memorize the sequence of the numbers associated with the pockets on the roulette wheel. Therefore, placing a BET on the numbers each associated with the pocket on both right and left sides of the predicted pocket is facilitated. As a result, it becomes easier for the player to place a BET such that the player can receive an award even when the ball does not land in the predicted pocket but in a nearby pocket on either the right or left side.

### BRIEF DESCRIPTION OF THE DRAWINGS

FIG. 1 is a flowchart illustrating game processing of a roulette game machine according to a first embodiment.

FIG. 2 is another flowchart illustrating game processing of a roulette game machine according to the first embodiment.

FIG. 3 is a flowchart illustrating game processing of a roulette game machine according to a second embodiment.

FIG. 4 is another flowchart illustrating game processing of a roulette game machine according to the second embodiment.

FIG. 5 is an external perspective view illustrating the general structure of a roulette game machine according to the first embodiment.

FIG. 6 is a plan view of a roulette device according to the first embodiment.

FIG. 7 is a view illustrating an exemplary image displayed to an image display device.

FIG. 8 is view illustrating an exemplary image displayed to an image display device.

FIG. 9 is view illustrating an exemplary image displayed to an image display device.

FIG. 10 is a view illustrating an exemplary image displayed to an image display device.

FIG. 11 is a block diagram illustrating an internal structure of a roulette game machine according to the first embodiment.

FIG. 12 is a schematic view illustrating a storage area of a ROM in a roulette game machine according to the first embodiment.

FIG. 13 is a schematic view illustrating a storage area of a RAM in a roulette game machine according to the first embodiment.

FIG. 14 is a block diagram illustrating an internal structure of a roulette device according to the first embodiment.

FIG. 15 is a block diagram illustrating an internal structure of a station according to the first embodiment.

FIG. 16 is a schematic view illustrating a storage area of a ROM in a station according to the first embodiment.

FIG. 17 is a flowchart illustrating sub BET reception processing according to the first embodiment.

FIG. 18 is a plan view of a roulette device according to the second embodiment.

FIG. 19 is a view illustrating exemplary control data according to the second embodiment.

FIG. 20 is a schematic view illustrating a storage area of a ROM in a roulette device according to the second embodiment.

### DESCRIPTION OF THE EMBODIMENTS

The embodiments according to the present invention will be described based on the drawings.

The first embodiment describes a case where a ball is housed in each of the pockets on a roulette wheel with the same probability (i.e., a case where the probabilities of the ball being housed is biased), and the second embodiment describes a case where a game apparatus is controlled so as to provide a relatively high weight on a probability that the ball is housed in particular pockets on the roulette wheel (i.e., a case where the probabilities of the ball being housed is biased).

First, descriptions will be given for game processing of the roulette game machine according to the first embodiment and of the roulette game machine according to the second embodiment.

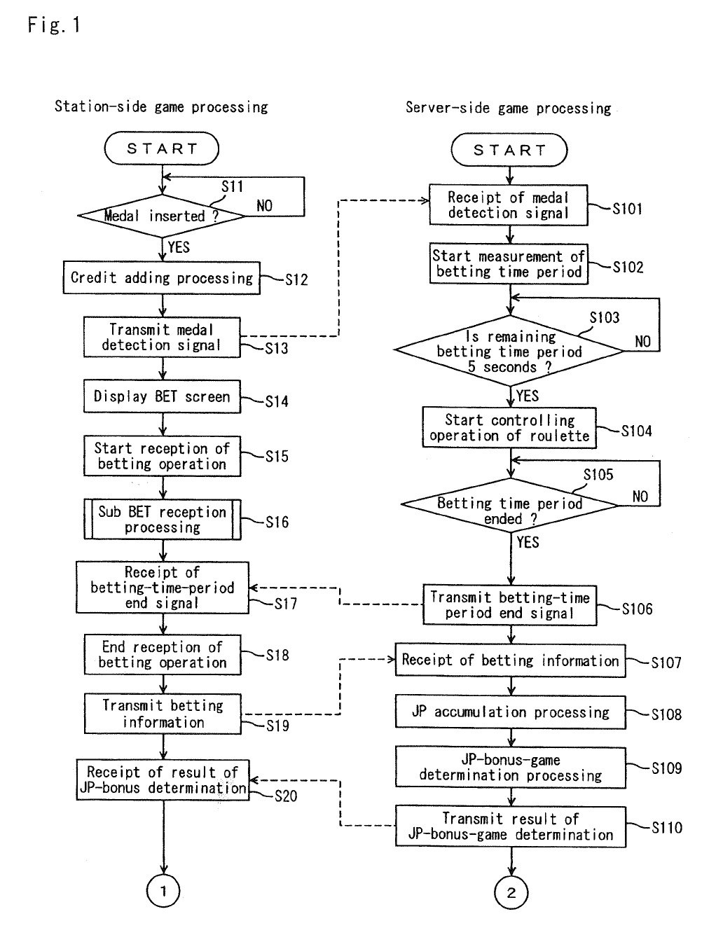

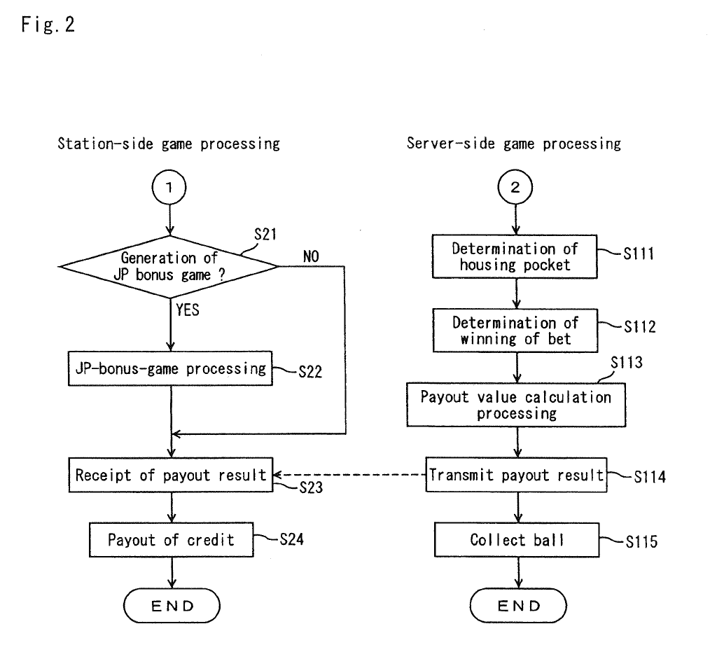

FIG. 1 and FIG. 2 are flowcharts illustrating game processing of a roulette game machine according to a first embodiment.

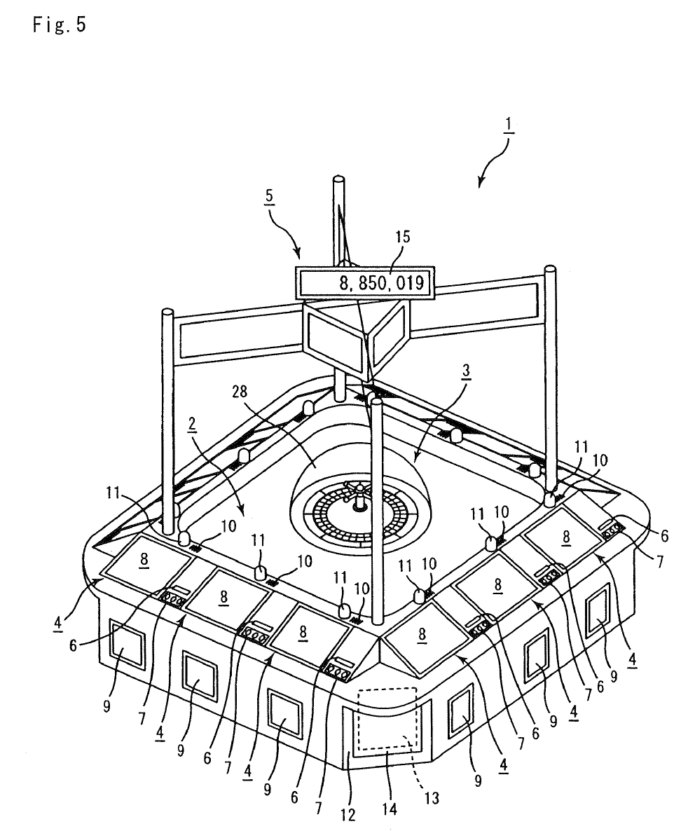

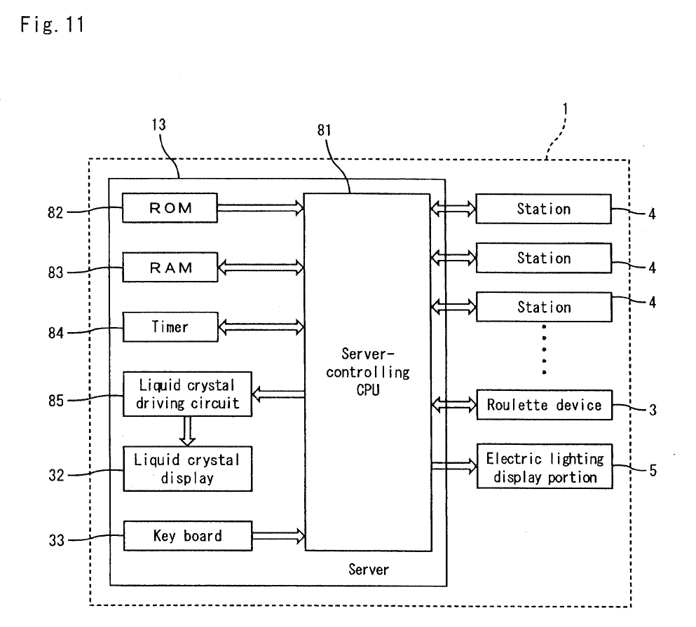

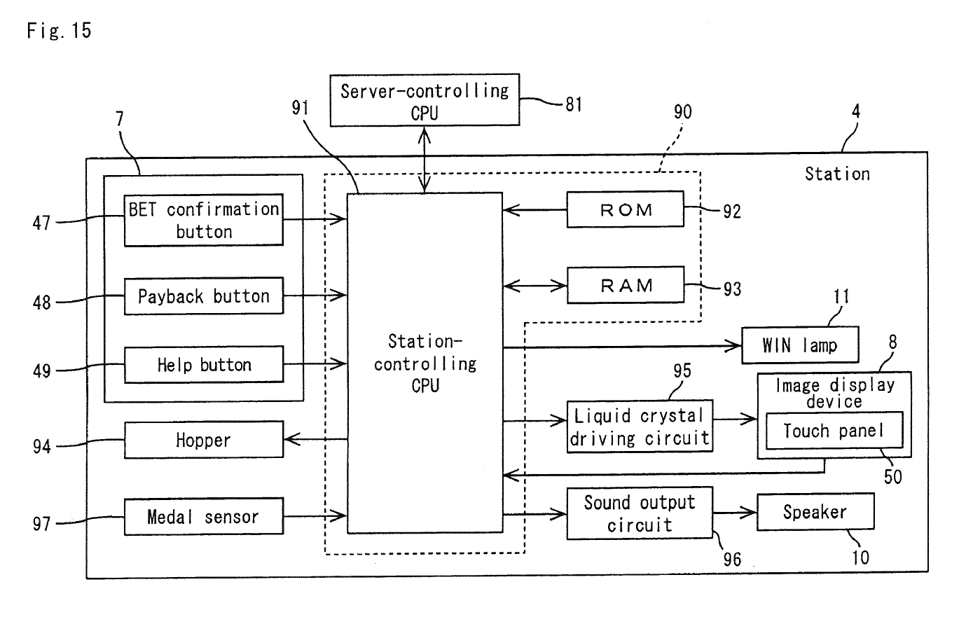

The processing is constituted of server-side game processing executed by a server-controlling CPU 81 (see FIG. 11) included in a roulette game machine 1 (see FIG. 5) according to the first embodiment, and station-side game processing executed by a station-controlling CPU 91 (see FIG. 15) included in the roulette game machine 1 according to the first embodiment.

The station-side game processing will be described, based on FIG. 1 and FIG. 2.

At first, in step S1, a station-controlling CPU 91 determines whether or not medals or coins have been inserted by the player, based on detection signals from a medal sensor 97 (see FIG. 15). If no medal or coin has been inserted (step S11: NO), the station-controlling CPU 91 waits for medals or coins to be inserted. On the other hand, if medals or coins have been inserted (step S11: YES), the processing proceeds to step S12.

In step S12, the station-controlling CPU 91 stores, in a RAM 93 (see FIG. 15), an amount of credit data corresponding to the number of inserted medals or coins. Next, in step S13, the station-controlling CPU 91 transmits, to a server 13 (see FIG. 11), a medal detection signal indicative of the presence of insertion of medals or coins.

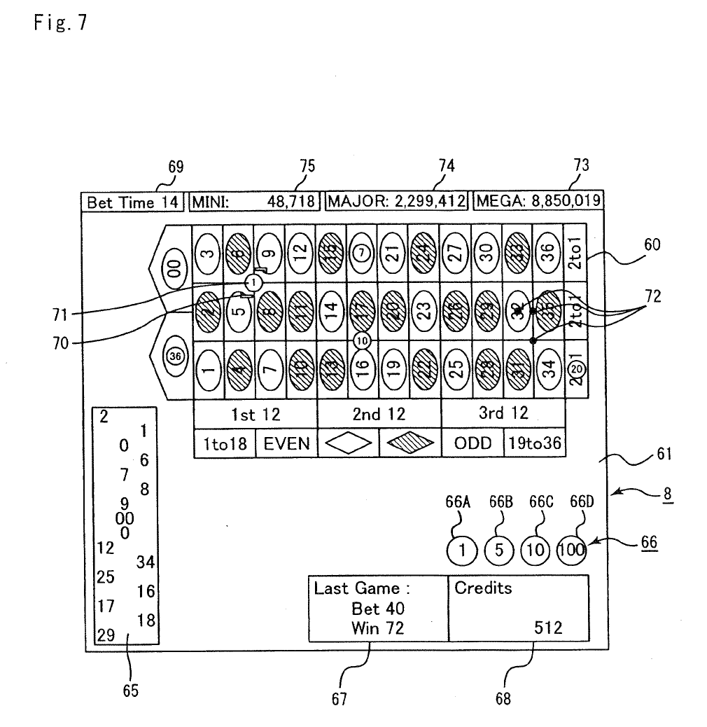

Next, in step S14, the station-controlling CPU 91 causes an image display device 8 (see FIG. 5) in the station 4 to display a BET screen 61. The BET screen 61 will be described in detail later, by using FIG. 7.

Next, in step S15, the station-controlling CPU 91 starts measuring a betting time period during which the player can bet chips.

Then, the player taking part in the game can bet his or her own chips on a BET area 72 (see FIG. 7) relating to a winning number that he or she predicts, by operating a touch panel 50 (see FIG. 15), during the betting time period during which betting can be received. Betting methods using the BET screen 61 will be described in detail later, by using FIG. 7.

Further, the player is allowed to take part in a game halfway therethrough after the start of the betting time period, and up to 12 players can play games with the roulette game machine 1 according to the present embodiment. Further, in cases where a current game is played subsequently to the previous game, the reception of betting operations is started immediately after the end of the previous game.

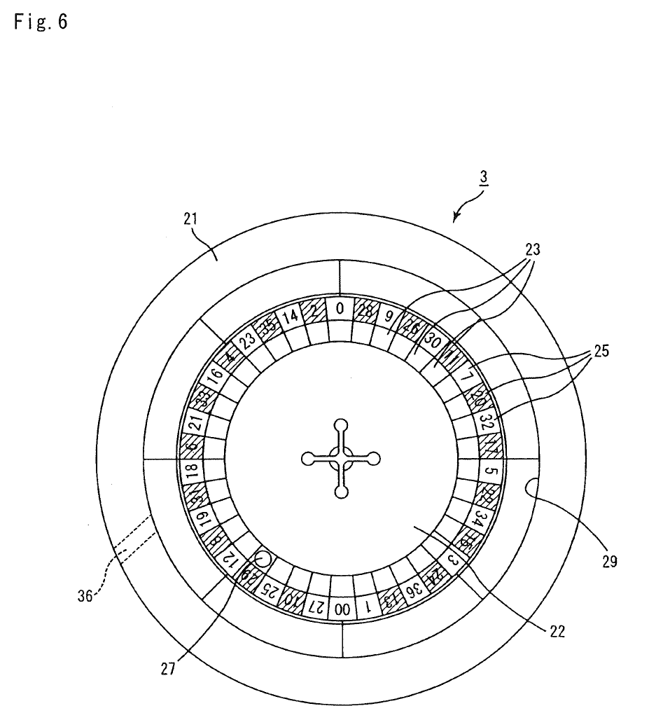

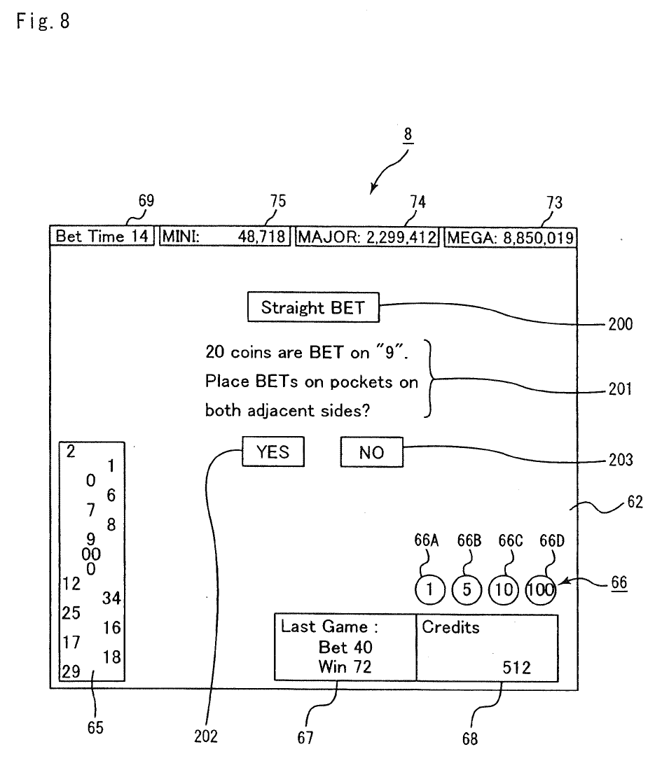

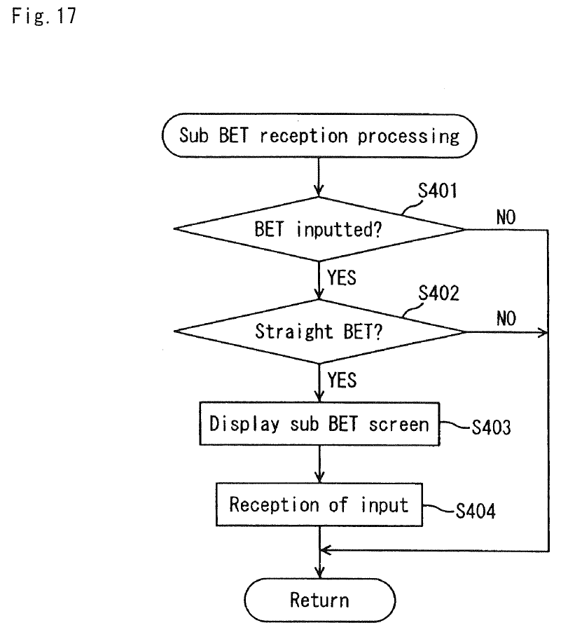

Next, in step S16, the station-controlling CPU 91 conducts sub BET reception processing. In the processing, when a BET inputted via the touch panel 50 is a straight BET, the station-controlling CPU 91 receives a sub BET, which is a BET on a number pocket 23 (see FIG. 6) on the right and left sides of the number pocket 23 on which the straight BET is placed. The sub BET reception processing will be described in detail later by using FIG. 17, and images to be displayed to the image display device 8 in the sub BET reception processing will be described in detail later by using FIG. 8 to FIG. 10.

Next, in step S17, on receiving a betting-time-period end signal indicative of the end of the betting time period from the server-controlling CPU 81, the station-controlling CPU 91 causes the image display device 8 in the station 4 to display an image indicative of the end of the betting time period, and ends the reception of betting operations through the touch panel 50 (step S18). Thereafter, the station-controlling CPU 91 transmits information on the betting that the player performed at the station 4 [the specified BET area 72, the number of chips betted on the specified BET area 72 (i.e., the number of BETs)] (step S19).

Next, in step S20, the station-controlling CPU 91 receives, from the server 13, the result of JP (jackpot)-bonus-game determination processing conducted by the server-controlling CPU 81, which will be described later. The result of JP-bonus-game determination includes the result of determination as to whether or not a predetermined JP bonus game should be generated at each station 4, the result of determination as to which station 4 out of the 12 stations 4 should win a JP (or as to whether all the stations 4 should not win the JP) if a JP bonus game should be generated, the result of determination as to which JP (“MEGA”, “MAJOR” or “MINI”) should be generated if a JP should be generated, and the like.

Next, in step S21 in FIG. 2, the station-controlling CPU 91 determines whether or not a JP bonus game should be generated, based on the result of the JP-bonus-game determination processing which was received in step S20. If the station-controlling CPU 91 determines that a JP bonus game should be generated at this station 4, the station-controlling CPU 91 executes a predetermined selectable JP bonus game relating to acquisition of JPs and causes the image display device 8 to display the result of the game (i.e., whether or not a JP was acquired), based on the result of determination received in step S20 (step S22).

If the station-controlling CPU 91 determines in step S21 that no bonus game should be generated at this station 4, or after the processing in step S22, the station-controlling CPU 91 receives the result of credit payout transmitted from the server-controlling CPU 81 (step S23). The result of credit payout is constituted by the result of payout in games and the result of JP payout in JP bonus games.

Next, in step S24, the station-controlling CPU 91 pays out credits, based on the result of payout received in step S23. More specifically, the station-controlling CPU 91 stores, in the RAM 93, an amount of credit data corresponding to the payout value of the game and, also, stores therein, an amount of credit data corresponding to the JP payout value accumulated until the present time in cases where a JP bonus game was generated and the present station 4 won a JP. Then, if a payback button 48 (see FIG. 15) is pushed, a number of medals corresponding to the number of credits currently stored in the RAM 93 (a single medal corresponds to a single credit, in general) are paid out from a medal payout port 9 (see FIG. 5).

If a game is continuously played at one of the stations 4 thereafter, the processing returns to step S14, then starts the betting time period again and enters the next game.

On the other hand, if the game is ended at all the stations 4, the game processing ends.

Based on FIG. 1 and FIG. 2, the server-side game processing will be described.

At first, in step S101, the server-controlling CPU 81 determines whether or not medals or coins have been inserted by the player, on receiving medal detection signals transmitted from the station-controlling CPU 91. In the roulette game machine 1 according to the present embodiment, if medals or coins are inserted at one of the stations 4, the station-controlling CPU 91 in the station 4 at which the medals or coins have been inserted transmits a medal detection signal to the server-controlling CPU 81.

Next, the server-controlling CPU 81 starts measurement of a betting time period, at the time point when the player who first takes part in the game inserts medals or coins (step S102). The betting time period is a time period during which players can perform inputs for betting. Players taking part in the game can bet their own chips on BET areas 72 relating to winning numbers they predict, by operating the touch panel 50 during the betting time period.

Next, in step S103, the server-controlling CPU 81 determines whether or not the remaining betting time period has reached 5 seconds. Further, the remaining betting time period is displayed to the BET time display portion 69 (see FIG. 7). If it is determined that the remaining betting time period has not reached 5 seconds, the processing is returned to step S103. On the other hand, if it is determined that the remaining betting time period has reached 5 seconds, the processing shifts to step S104.

In step S104, the server-controlling CPU 81 transmits a control signal for starting an operation of a roulette device 3 (see FIG. 5), to the CPU 101 in the roulette device 3. The CPU 101, on receiving the control signal, controls operations as follows.

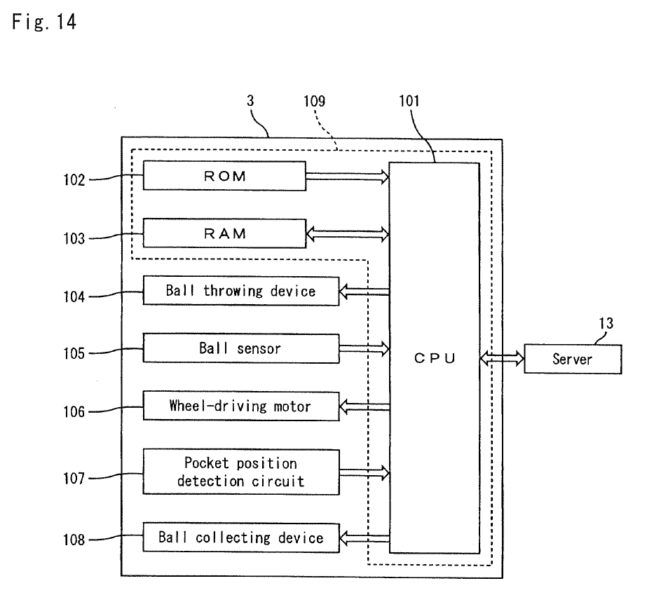

First, the CPU 101 drives a wheel driving motor 106 (see FIG. 14) to rotate a roulette wheel 22 (see FIG. 6), only during a previously defined motor driving time.

Then, after the elapse of a predetermined time period (for example, 20 seconds) since the start of the rotation of the roulette wheel 22, the CPU 101 throws a ball 27 (see FIG. 6) after the elapse of a launching delay time since detection of a detection signal from a pocket-position detection circuit 107 (see FIG. 14). At this time, the ball 27 is thrown at a previously defined initial speed. Here, the launching delay time is from the time a predetermined number pocket 23 has passed a predetermined position until the ball is launched, during rotation of the roulette wheel 22.

Next, in step S105, the server-controlling CPU 81 determines whether or not the betting time period has ended. If the server-controlling CPU 81 determines that the betting time period has not ended, it waits for the end of the betting time period.

On the other hand, if the server-controlling CPU 81 determines that the betting time period has ended, the server-controlling CPU 81 transmits a betting-time-period end signal indicative of the end of the betting time period, to the station-controlling CPU 91 (step S106).

Next, in step S107, the server-controlling CPU 81 receives, from the station-controlling CPU 91, information on the betting that the player performed at each station 4 (i.e., information on the specified BET area 72, the number of chips betted on the specified BET area 72 [i.e., the number of BETS]) and the betting method) and stores it in a BET information storage area 83A (see FIG. 13) in the RAM 83.

Next, in step S108, the server-controlling CPU 81 cumulatively adds a number of credits corresponding to 0.30% of the sum of the credits betted at all the stations 4, which were received in step S107, to the JP value stored in a “MINI” JP cumulative storage area 83C (see FIG. 13) in the RAM 83. Further, the server-controlling CPU 81 cumulatively adds a number of credits corresponding to 0.20% of the sum of the credits to the JP value stored in a “MAJOR” JP cumulative storage area 83D (see FIG. 13) in the RAM 83. Further, the server-controlling CPU 81 cumulatively adds a number of credits corresponding to 0.15% of the sum of the credits to the JP value stored in a “MEGA” JP cumulative storage area 83E (see FIG. 13) in the RAM 83. Further, based on these JP values, the server-controlling CPU 81 updates the displays to a JP-value display portion 15 (see FIG. 5), a MEGA display portion 73, a MAJOR display portion 74 and a MINI display portion 75 (see FIG. 7).

Next, in step S109, the server-controlling CPU 81 conducts JP-bonus-game determination processing. In this processing, using random numbers sampled by a sampling circuit and the like, the server-controlling CPU 81 determines whether or not a JP bonus game should be generated at each station 4, determines which station 4 out of the 12 stations 4 should win a JP (or whether all the stations 4 should not win a JP) if a JP bonus game should be generated, and also determines which JP (“MEGA”, “MAJOR” or “MINI”) should occur if a JP should be generated.

Next, at step S110, the server-controlling CPU 81 transmits the result of JP bonus game determination to each station 4, based on the processing in step S109.

Next, in step S111 in FIG. 2, the server-controlling CPU 81 transmits a control signal to the roulette device 3 to drive a ball sensor 105 (see FIG. 14), thereby determining which number is associated with the number pocket 23 (see FIG. 6) in which the ball 27 has been housed.

Next, the server-controlling CPU 81 determines whether or not winning relating to the chips betted at each station 4 has occurred, from the betting information on each station 4 which was received in step S107 and the type of the pocket determined in step S111 (step S112).

It is to be noted that regarding the BET placed by the player as a winning BET in a game corresponds to offering a prize in the present invention.

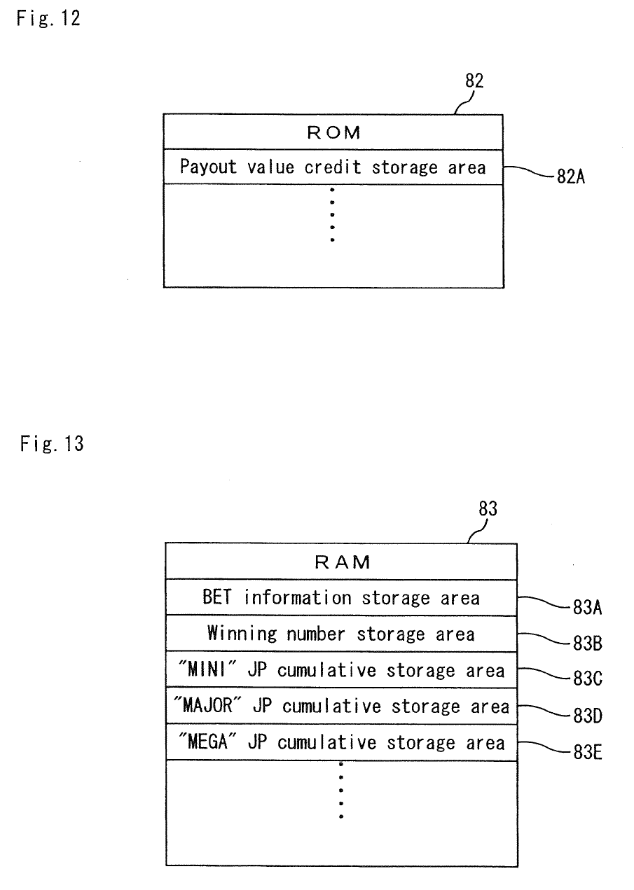

In step S113, the server-controlling CPU 81 conducts payout value calculation processing. In the payout value calculation processing, the server-controlling CPU 81 recognizes the winning chips betted on the winning number at each station 4 and calculates the sum of the payout value of credits to be paid out for each station 4, using the payout value ratios for the respective BET areas 72 [i.e., the numbers of credits to be paid out for a single chip (1 BET)] stored in a payout value credit storage area 82A (see FIG. 12) in a ROM 82 (see FIG. 11).

Next, in step S114, the server-controlling CPU 81 conducts processing for transmitting the result of credit payout in games based on the payout value calculation processing in the step S113 and the result of JP payout based on the JP-bonus-game determination processing in the step S109. More specifically, the server-controlling CPU 81 issues credit data corresponding to the amount of payout values resulted from games to the station-controlling CPU 91 in the station 4 which won the games. Further, when a JP is generated, the server-controlling CPU 81 further issues credit data corresponding to the JP value accumulated until the present time.

Next, in step S115, the server-controlling CPU 81 transmits a control signal to the roulette device 3 to drive a ball collecting device 108 (see FIG. 14) provided under the roulette wheel 22 for collecting the ball 27 thrown onto the roulette wheel 22. The collected ball 27 will be thrown into the roulette wheel 22 in the roulette device 3 again in subsequent games.

After the processing in step S115, the present subroutine is terminated.

It is to be noted that the first embodiment will be described later by using the drawings.

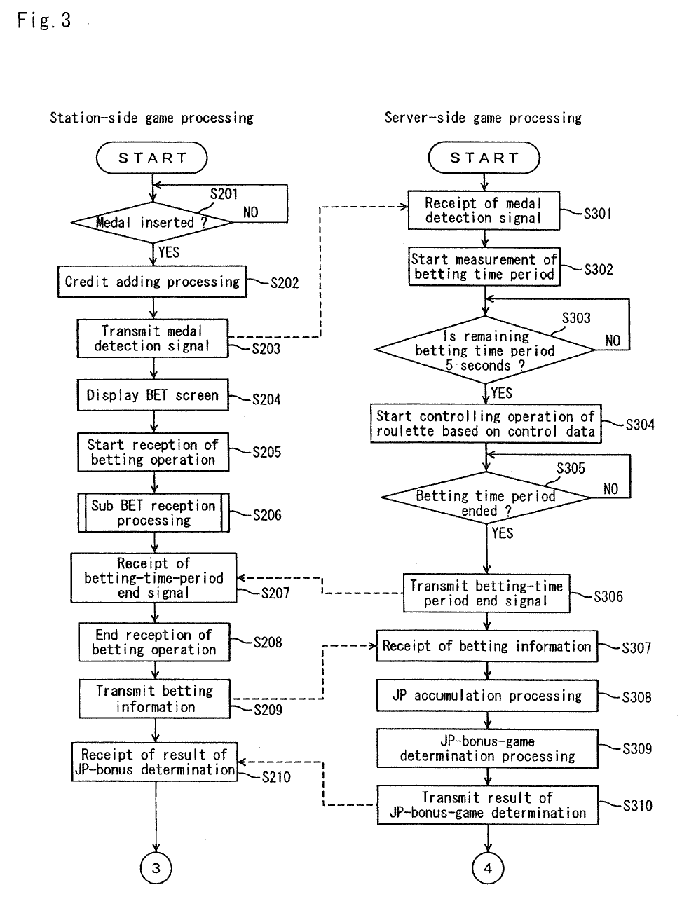

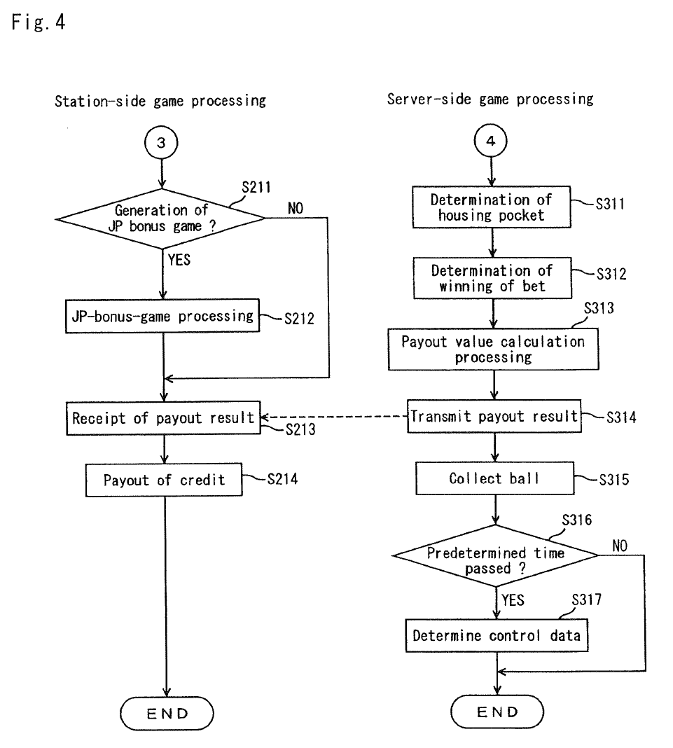

FIG. 3 and FIG. 4 are flowcharts illustrating game processing of a roulette game machine according to the second embodiment.

In the second embodiment, same numerals are given to the constituents corresponding to those of the roulette game machine according to the first embodiment.

The second embodiment is different from the first embodiment in that the roulette game machine 1 is controlled, by the control data stored in a ROM 102 (see FIG. 14), so as to provide different weights on probabilities that the ball 27 is housed in each of the number pockets 23 on the roulette wheel 22 (to provide a relatively high weight on a probability that the ball 27 is housed in particular number pockets 23). As described later, a plurality of types of control data are stored, and the control data to be the reference target is switched every time a predetermined condition (in the second embodiment, to reach a predetermined time) is satisfied.

Since step S201 to step S214 in the station-side game processing are similar to step S11 to step S24 in the station-side game processing according to the first embodiment, descriptions thereof are omitted here.

Next, the server-side game processing will be described based on FIG. 3 and FIG. 4.

Since the processing of step S301 to step S303 is similar to the processing of step S101 to step S103 in the server-side game processing according to the first embodiment, descriptions thereof are omitted here.

In step S304, the server-controlling CPU 81 transmits a control signal for starting an operation of the roulette device 3, to the CPU 101 in the roulette device 3. The CPU 101, on receiving the control signal, controls operations as follows by referring to the control data stored in the ROM 102.

First, the CPU 101 drives the wheel driving motor 106 to rotate the roulette wheel 22, only during a motor driving time defined by the control data.

Then, after the elapse of a predetermined time period (for example, 20 seconds) since the start of the rotation of the roulette wheel 22, the CPU 101 throws the ball 27 after the elapse of a launching delay time since detection of a detection signal from the pocket-position detection circuit 107. At this time, the ball 27 is thrown at an initial speed defined by the control data.

Thereby the thrown ball 27 is to be housed, with a relatively high probability, in any of the number pockets 23 belonging to a particular area on the roulette wheel 22.

As the control data to be referred, single control data has been pre-set as a reference target, at the time of activation of the roulette game machine 1. Further, when another control data is set as the reference target, this another control data is referred to as the reference target.

Since the subsequent processing of step S305 to step S315 is similar to the processing of step S105 to step S115 in the server-side game processing according to the first embodiment, descriptions thereof are omitted here.

Next, in step S316, the server-controlling CPU 81 determines whether or not the predetermined time (in the present embodiment, the 0th minute of every hour) has come. If it is determined that the predetermined time has come, the server-controlling CPU 81 determines control data (step S317). More specifically, the server-controlling CPU 81 informs the CPU 101 of the roulette device 3 that the predetermined time has come. The CPU 101, on receiving the information, conducts random number sampling and determines a control data different from the control data currently set as the reference target, out of the plurality of control data stored in the ROM 102 and sets the determined control data as a reference target, based on the acquired random number.

If it is determined in step S316 that the predetermined time has not come, or after the processing of step S317, the present subroutine is terminated.

It is to be noted that the second embodiment will be described later by using the drawings.

### First Embodiment

First, the structure of the roulette game machine 1 will be described.

FIG. 5 is an external perspective view illustrating the general structure of a roulette game machine according to the first embodiment.

While the roulette game machine 1 is a standalone type game machine which is not connected to a network, the present invention can be applied to a game machine connected to a network.

As illustrated in FIG. 5, the roulette game machine 1 includes the cabinet 2 forming a main body, the roulette device 3 provided at a substantially center portion of the upper surface of the cabinet 2, a plurality of stations 4 (12 stations, in the present embodiment) installed around the roulette device 3 to surround the roulette device 3, and an electric lighting display portion 5 provided above the cabinet 2.

The stations 4 include, at least, a medal insertion port 6 for inserting a currency value of coins or game mediums such as chips or medals for use in games, a control portion 7 constituted by a plurality of control buttons and the like which enable a player to input predetermined commands, and an image display device 8 capable of displaying images relating to games. Further, the stations 4 receive betting operations by the player. The player can process games being deployed, by operating the touch panel, the control portion 7 and the like, while looking at the image being displayed to the image display device 8.

Further, medal payout ports 9 are provided in the side surfaces of the cabinet 2 in which the stations 4 are installed. Further, above the image display devices 8 in the respective stations 4, to the right thereof, there are provided speakers 10 for generating music, effect sounds and the like.

Above the image display devices 8 in the respective stations 4, there are provided WIN lamps 11. In the event of the occurrence of winning relating to numbers (“0”, “00” or “1” to “36” in the present embodiment) on which the player betted at the station 4 during a game, the WIN lamp 11 in the winning station 4 is lighted. Further, during JP (jackpot) bonus games for acquiring a jackpot (hereinafter, referred to as “JP”), in the event that a station 4 acquires a JP, the WIN lamp 11 in the station 4 which acquired the JP is similarly lighted. Further, the WIN lamps 11 are provided at positions viewable from all the installed stations 4 (12 stations, in the present embodiment), which enable other players playing games with the same roulette game machine 1 to recognize the WIN lamps 11 being lighted anytime.

Inside of each medal insertion port 6, there is provided a medal sensor (not illustrated) which distinguishes the currency value inserted from the medal insertion port 6, such as medals, and counts the inserted medals. Further, inside of each medal payout port 9, there is provided a hopper (not illustrated) which pays out predetermined numbers of medals from the medal payout port 9.

A server 13 is placed inside of a corner portion 12 positioned at a corner of the cabinet 12. The server 13 is housed within the corner portion 12 in general in order to prevent it from being operated by players, but a corner door 14 provided at the corner portion 12 can be opened using a key switch in order to enable operations of the server 13. Further, by operating the server 13, various types of setting can be made for the roulette game machine 1.

In the electric lighting display portion 5, there is provided a JP-value display portion 15 which displays the value of JP. In the roulette game machine 1 according to the present embodiment, as will be described later, there are prepared 3 types of JP, i.e., “MEGA”, “MAJOR” and “MINI”. For the JP “MEGA”, 0.15% of the credits betted during games at all the 12 stations 4 are cumulatively stored. For the JP “MAJOR”, 0.20% of the betted credits are cumulatively stored. For the JP “MINI”, 0.30% of the betted credits are cumulatively stored. Further, in the event that the player wins any one of the JPs during JP bonus games, credits corresponding to the cumulative value accumulated for the corresponding JP are paid out to a predetermined station 4. The JP-value display portion 15 displays the cumulative value for the JP “MEGA”, out of the three types of JP. Further, the JP-value display portion 15 is provided at the top portion of the electric lighting display portion 5, which enables all players playing games at the stations 4 to view the content of the display thereon.

FIG. 6 is a plan view of a roulette device according to the first embodiment.

As illustrated in FIG. 6, the roulette device 3 included in the roulette game machine 1 includes a frame member 21 secured to the cabinet 2, and a roulette wheel 22 which is rotatably housed and supported inside the frame member 21. On an upper surface of the roulette wheel 22, there are formed a large number of concave-shaped number pockets 23 (a total of 38 number pockets in the present embodiment). Further, on the upper surface of the roulette wheel 22 in the outer directions of the respective number pockets 23, there are formed number display plates 25 displaying respective numbers of “0”, “00”, and “1” to “36”, in association with the respective number pockets 23.

The number pockets 23 correspond to the pockets in the present invention.

A ball throwing port 36 is formed in the frame member 21. A ball throwing device 104 (see FIG. 14) is connected to the ball throwing port 36, so that a ball 27 can be thrown onto the roulette wheel 22 from the ball throwing port 36 by being driven by the ball throwing device 104. Further, the roulette device 3 is entirely covered with a hemispherical transparent acrylic cover member 28 (see FIG. 5) thereabove.

Below the roulette wheel 22, there is provided the wheel-driving motor 106, so that the roulette wheel 22 is rotated by being driven by the wheel driving motor 106.

Further, metal plates (not illustrated) are mounted at predetermined intervals below the roulette wheel 22, and these metal plates are detected by a proximity sensor included in the pocket position detection circuit 107, which enables detecting the positions of the number pockets 23.

The frame member 21 is gently inclined in an inward direction, and a guide wall 29 is formed at a middle position thereof. The guide wall 29 is for guiding the thrown ball 27 against a centrifugal force to cause the ball 27 to roll. As a rotation speed of the ball 27 decreases and, thus, the centrifugal force thereof decreases, the ball 27 rolls along the inclined surface of the frame member 21 and travels inwardly to reach the rotating roulette wheel 22. Then, the ball 27 which has rolled and reached the roulette wheel 22 passes over the number display plates 25 outside the still rotating roulette wheel 22 and then is housed in one of the number pockets 23. As a result, the ball sensor 105 detects the number displayed to the number display plate 25 corresponding to the number pocket 23 housing the ball, and this number becomes a winning number.

FIG. 7 to FIG. 10 are views illustrating an exemplary image displayed to an image display device.

FIG. 7 illustrates the BET screen 61 displayed to the image display device 8, at the time of accepting BETs.

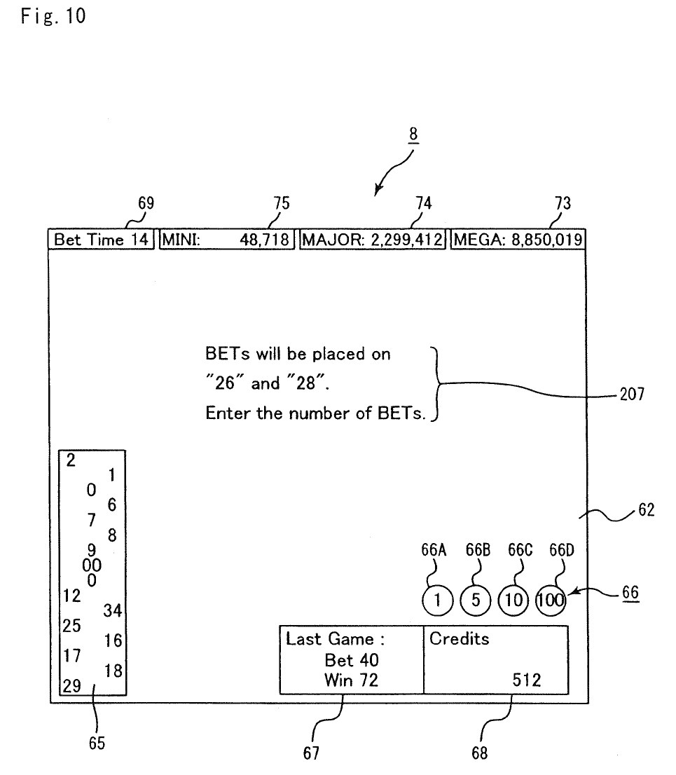

As illustrated in FIG. 7, the image display device 8 displays, thereto, a BET screen 61 having a table-type betting board 60. The player can bet chips using his or her own credits, by operating the touch panel 50 (see FIG. 10) provided in the front surface of the image display device 8.

First, based on FIG. 7, there will be described the BET screen 61 which is displayed during games. In the table-type betting board 60 being displayed in the BET screen 61, 38 types of numbers “0”, “00” and “1” to “36” are displayed and arranged in a grid shape. Further, specific BET areas are similarly arranged in a grid shape, wherein the specific BET areas are for specifying “odd numbers”, “even numbers”, “the types of colors of the number display plates (red or black)”, “certain numerical ranges (for example, “1” to “12” and the like) so that chips can be betted thereon.

Under the table-type betting board 60, there are displayed a result history display portion 65, unit BET buttons 66, a payback result display portion 67, and a number-of-credit display portion 68.

The result history display portion 65 displays a list of winning numbers resulted from the previous games (in this case, “a single game” refers to a series of operations starting with betting by a player in any of the stations 4 and then throwing the ball 27 into the number pockets 23 and ending with paying back credits based on the winning number). In this case, when a single game ends, a new winning number is added and displayed to the top of the list, which enables recognizing the history of winning numbers resulted from up to 16 games.

Further, the unit BET buttons 66 are for betting chips on a BET area 72 (over a grid having a number or mark or over a line defining grids) specified by the player. The unit BET button 66 is constituted by four buttons, which are a 1-BET button 66A, a 5-BET button 66B, a 10-BET button 66C and a 100-BET button 66D.

At first, the player specifies a BET area 72 on which he or she desires to bet, with a cursor 70 which will be described later, by directly pushing it on the screen. By pushing the 1-BET button 66A at this state, the player can bet one chip at a time (i.e., every time the 1-BET button 66A is pushed with fingers or the like, the number of BETs is increased in the order of “1”, “2”, “3” and so forth). By pushing the 5-BET button 66B, the player can bet five chips at a time (i.e., every time the 5-BET button 66B is pushed with fingers or the like, the number of BETs is increased in the order of “5”, “10”, “15” and so forth). By pushing the 10-BET button 66C, the player can bet ten chips at a time (i.e., every time the 10-BET button 66C is pushed with fingers or the like, the number of BETs is increased in the order of “10”, “20”, “30” and so forth). Further, by pushing the 100-BET button 66D, the player can bet 100 chips at a time (every time the 100-BET button 66D is pushed with fingers or the like, the number of BETs is increased in the order of “100”, “200”, “300” and so forth).

The payback result display portion 67 displays the number of chips betted by the player and the number of paid-back credits in the previous game. In this case, the number of paid-back credits minus the number of betted chips indicates the number of credits that the player newly acquired in the previous game.

The number-of-credit display portion 68 displays the number of credits possessed by the current player. If chips are betted, the number of credits is decreased by an amount corresponding to the number of BETs (1 BET corresponds to 1 credit). In the event of that winning relating to the betted chips occurs and credits are paid back, the number of credits is increased by the number of paid-back credits. Further, if the number of credits possessed by the player becomes 0, the games end.

Further, above the table-type betting board 60, a BET time display portion 69 is provided. The BET time display portion 69 displays the remaining time during which the player can bet. The BET time display portion 69 displays “20” at the start of reception of betting operations, then decreases the number by one at every second and displays “0” at the end of reception of betting operations. Further, when the remaining betting time for the player reaches 5 seconds at each station 4, the ball throwing device is driven to throw the ball 27 onto the roulette board.

Further, to the right of the BET-time display portion 69, there are provided a MEGA display portion 73 which displays the number of credits accumulated for the JP “MEGA” until the present time, a MAJOR display portion 74 which displays the number of credits accumulated for the JP “MAJOR” until the present time, and a MINI display portion 75 which displays the number of credits accumulated for the JP “MINI” until the present time. The MEGA display portion 73 displays a number of credits resulted from cumulatively accumulating 0.15% of the credits betted in every single game at all 12 stations 4. The MAJOR display portion 74 displays a number of credits resulted from cumulatively accumulating 0.20% of the betted credits. The MINI display portion 75 displays a number of credits resulted from cumulatively accumulating 0.30% of the betted credits. The MEGA display portion 73, the MAJOR display portion 74 and the MINI display portion 75 display numerical values which are common among all the stations 4. In the event that the player wins a JP during a JP bonus game, the credits for the JP won by the player are paid out, out of the three types of JP displayed to the display portions 73 to 75, and, after the paying out, the JP display portion displays an initial numerical value (i.e., 200 credits for “MINI”, 5000 credits for “MAJOR” and 50000 credits for “MEGA”).

Further, on the table-type betting board 60, the cursor 70 indicating the BET area 72 being currently selected by the player is displayed. Further, a chip mark 71 indicating the number of chips betted up to the present time and the BET area 72 is displayed, wherein the number displayed to the chip mark 71 indicates the number of betted chips. For example, as illustrated in FIG. 7, a “7” chip mark 71 placed on the “18” grid indicates that 7 chips are being betted on the number “18”. Further, such a method for betting on only a single number is a betting method called “straight BET”.

Further, a “1” chip mark 71 placed at the intersection of the “5”, “6”, “8” and “9” grids indicates that all the four numbers are covered, meaning a single chip is being betted on the four numbers “5”, “6”, “8” and “9”. Further, such a method covering four numbers for betting on the four numbers is a betting method called “corner BET”.

As other betting methods, there are “split BET” which covers two numbers using the line between the two numbers so as to bet on two numbers; “street BET” which covers three numbers using an end of a lateral single row of numbers (a vertical single row, in FIG. 7) so as to bet on three numbers (for example, “13”, “14” and “15”); “five BET” which covers five numbers using the line between the numbers “00” and “3” so as to bet on five numbers “0”, “00”, “1”, “2” and “3”; “line BET” which covers six numbers using the space between two lateral rows of numbers (two vertical rows in FIG. 4) so as to bet on six numbers (for example, “13”, “14”, “15”, “16”, “17” and “18”); “column BET” which covers twelve numbers using a “2-to-1” grid so as to bet on twelve numbers; and “dozen Bet” which cover twelve numbers using any of “1st-12”, “2nd-12” and “3rd-12” grids so as to bet on twelve numbers. Further, there is a method which covers 18 numbers so as to bet on 18 numbers, by specifying the 18 numbers from any of the colors of the number display plates (“red” or “black”), odd numbers or even numbers, and numbers equal to or less than 18 or numbers equal to or greater than 19, using 6 grids provided at the lowermost stage of the table-type betting board 60. The above-mentioned plurality of betting methods result in different credit payout values (payout value ratios) per single chip, in the event of the occurrence of winning relating to betted chips.

When a player performs betting through the BET screen 61 having the above-mentioned configuration, the player specifies a BET area 72 (over a grid having a number or mark or over a line defining grids) on which he or she desires to bet, by directly pushing it on the screen with his or her finger. As a result, the cursor 70 moves to the specified BET area 72.

Thereafter, by pushing each unit button (the 1-BET button 66A, the 5-BET button 66B, the 10-BET button 66C and the 100-BET button 66D), out of the unit BET buttons 66, a number of chips corresponding to the number of units are betted on the specified BET area 72. For example, by pushing the 10-BET button 66C four times, pushing the 5-BET button 66B a single time and pushing the 1-BET button 66A three times, it is possible to bet a total of 48 chips.

In the present embodiment, if the inputted BET is a straight BET, a sub BET is received on the number pocket 23 on the right and left sides of the pocket of the number on which the straight BET has been placed.

FIG. 8 illustrates an exemplary image displayed to an image display device 8 in the even that a straight BET has been inputted.

In the even that a straight BET has been inputted, a sub BET screen 62 is displayed as illustrated in FIG. 8. To the sub BET screen 62, there are displayed: an image 200 indicating that the straight BET has been placed; an image 201 indicating the number of the number pocket 23 with the straight BET placed thereon and the number of BETs thereof, and also asking the player as to whether or not he or she desires to place a BET (sub BET) on a pocket on the right and left sides of the number pocket 23; and images 202, 203 indicating a button for inputting the answer to the question (namely, whether or not to place a sub BET).

In FIG. 8, the image 201 indicates that 20 chips of straight BET have been placed on the number pocket 23 of number “9”.

The player touches the area, on the touch panel 50, corresponding to the image 202 of “YES” in the case of placing the sub BET, or touches the area, on the touch panel 50, corresponding to the image 203 of “NO” in the case of not placing the sub BET, the respective areas being provided.

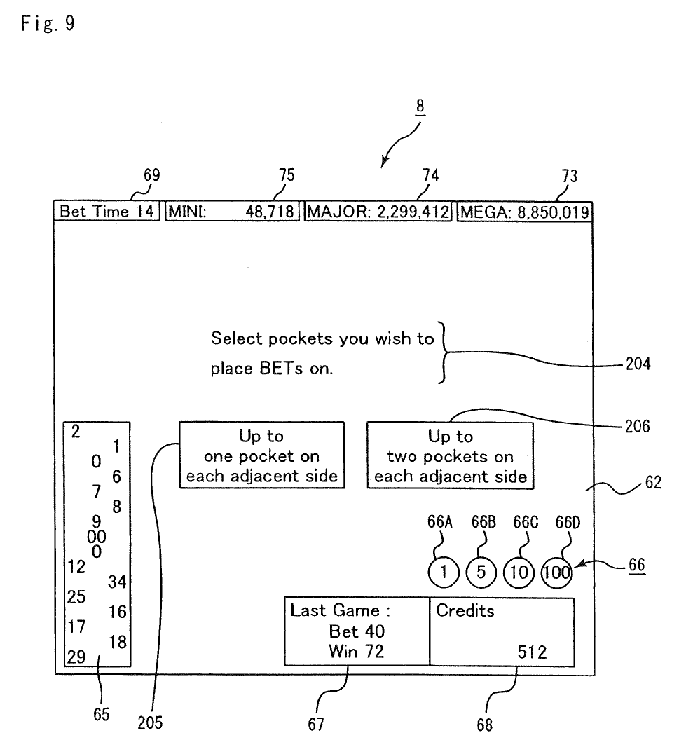

FIG. 9 illustrates an exemplary image displayed to the image display device 8 in an event that the input of placing a sub BET has been entered on the sub BET screen 62 illustrated in FIG. 8.

In the even that the input of placing a sub BET has been entered, there are displayed, as illustrated in FIG. 9, an image 204 prompting the player to select number pockets 23 to place the sub BET on, and images 205, 206 indicating buttons for selecting number pockets 23 to place the sub BET on.

Selecting “Up to one pocket on each adjacent side” indicated by the image 205 allows the player to place the sub BET on the number pocket 23 on both adjacent sides of the number pocket 23 on which the straight BET has been placed; selecting “Up to two pockets on each adjacent side” indicated by the image 206 allows the player to place the sub BET on the number pocket 23 on both adjacent sides of the number pocket 23 on which the straight BET has been placed, and on the number pocket 23 on an adjacent side of these respective adjacent number pockets 23.

The number pockets 23 on both adjacent sides of the number pocket 23 on which the straight BET has been placed corresponds to the adjacent pocket in the present invention.

FIG. 10 illustrates an exemplary image displayed to the image display device 8 in an event that the input of placing a sub BET “up to one pocket on each adjacent side” has been entered in the state shown in FIG. 9.

To the image display device 8, there is displayed, as illustrated in FIG. 10, an image 207 indicating that the sub BET is to be placed on a number pocket 23 on both adjacent sides of the number pocket 23 on which the straight BET has been placed, and prompting an input of the number of BETs for the sub BET.

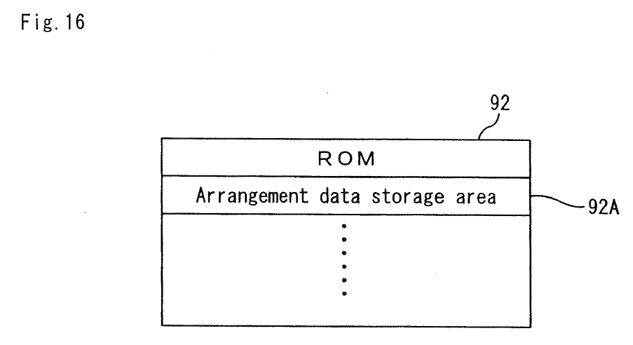

As illustrated in FIG. 8, since the straight BET is currently placed on the number pocket 23 of “9”, the image 207 is indicating that the sub BET is to be placed on the number pockets 23 of “26” and “28” (see FIG. 6), which are on the respective adjacent sides of the number pocket 23 of “9”. As described later, in the present embodiment, the ROM 92 included in the stations 4 stores the arrangement data indicating the sequence of the number pockets 23 on the roulette wheel 22 (see FIG. 16), and the station-controlling CPU 91 determines the numbers of the number pockets 23 which are on the respective adjacent sides of the number pocket 23 on which the straight BET has been placed, based on the number of the number pocket 23 with the straight BET placed thereon by an input from the touch panel 50, and the arrangement data stored in the ROM 92.

The reception of the sub BET is completed when the number of BETs has been inputted via the unit BET buttons 66.

FIG. 11 is a block diagram illustrating the internal structure of the roulette game machine according to the first embodiment.

As illustrated in FIG. 11, the roulette game machine 1 is constituted by the server 13 and the plurality of stations 4 (12 stations in the present embodiment) connected to the server 13, wherein the roulette device 3 and the electric lighting display portion 5 are connected to the server 13. Further, the internal structures of the roulette device 3 and the stations 4 will be described in detail later.

The server 13 includes a server-controlling CPU 81 which controls the entire server 13, a ROM 82, a RAM 83, a timer 84, a liquid crystal display 32 connected through a liquid crystal driving circuit 85, and a key board 33.

The server-controlling CPU 81 conducts various types of processing, based on input signals supplied from the respective stations 4 and data and programs stored in the ROM 82 and the RAM 83. Then, based on the results thereof, the server-controlling CPU 81 transmits command signals to the stations 4, to control the respective stations 4 in an initiative manner. Particularly, the server-controlling CPU 81 transmits control signals to the roulette device 3 to control the launching of the ball 27 and the rotation of the roulette wheel 22.

The ROM 82, which is constituted by, for example, a semiconductor memory, stores programs for realizing basic functions of the roulette game machine 1, programs for setting and managing annunciation of maintenance times and conditions to be announced, programs for controlling, in an initiative manner, payout value ratios for roulette games (the numbers of credits to be paid out for winning per single chip) and the respective stations 4, and the like.

On the other hand, the RAM 83 temporarily stores information on betted chips supplied from the respective stations 4, winning numbers of the roulette device 3 determined by a sensor, JP values accumulated until the present time, data about the results of processing executed by the server-controlling CPU 81, and the like.

The server-controlling CPU 81, the ROM 82, and the RAM 83 correspond to the controller in the present invention.

Further, the timer 84 for use in time measurement is connected to the server-controlling CPU 81.

Time information from the timer 84 is transmitted to the server-controlling CPU 81, which controls rotation operation on the roulette wheel 22 and throwing in of the ball 27, based on the time information from the timer 84, as will be described later.

Further, the electric lighting display portion 5 (see FIG. 5) is connected to the server-controlling CPU 81. Further, the server-controlling CPU 81 controls light emission from LEDs and the like for performing illumination effects and also for displaying predetermined characters and the like to the electric lighting display portion 5. Further, the server-controlling CPU 81 especially causes the JP-value display portion 15 in the electric lighting display portion 5 to display the value of a JP (JP “MEGA” in the present embodiment) which has been accumulated until the present time.

FIG. 12 is a schematic view illustrating the storage area of the ROM in the roulette game machine according to the first embodiment.

As illustrated in FIG. 12, the ROM 82 is provided with a payout value credit storage area 82A which stores payout value ratios relating to games. Further, as payout value ratios for the respective BET areas 72 in the BET screen 61 stored in the payout value credit storage area 82A, there have been stored, in advance, predetermined ratios “×2” to “×36”, depending on the types of betting methods (such as “straight BET”, “corner BET”, “split BET” and the like).

FIG. 13 is a schematic view illustrating the storage area of the RAM in the roulette game machine according to the first embodiment.

As illustrated in FIG. 12, the RAM 83 is provided with a BET information storage area 83A which stores information on betting by players currently playing games, a winning-number storage area 83B which stores a winning number of the roulette device 3 determined by the ball sensor 105, a “MINI” JP cumulative storage area 83C which stores the number of credits cumulatively accumulated for the JP “MINI”, a “MAJOR” JP cumulative storage area 83D which stores the number of credits cumulatively accumulated for the JP “MAJOR”, and a “MEGA” JP cumulative storage area 83E which stores the number of credits cumulatively accumulated for the JP “MEGA”. Further, more specifically, the betting information is information on betting performed through the stations 4, such as BET areas 72 (see FIG. 7) specified on the BET screen 61, the numbers of betted chips (the numbers of BETs), the betting methods, the number of the number pocket 23 inputted on the sub BET screen 62, and the number of BETs for the sub BET.

FIG. 14 is a block diagram illustrating the internal structure of the roulette device according to the first embodiment.

As illustrated in FIG. 14, the roulette device 3 includes a control portion 109, the pocket position detection circuit 107, the ball throwing device 104, the ball sensor 105, the wheel driving motor 106 and a ball collecting device 108. The control portion 109 corresponds to a controller according to the present invention.

The control portion 109 includes a CPU 101, a ROM 102 and a RAM 103. The CPU 101 controls the launching of the ball 27 and the rotation of the roulette wheel 22, based on control signals supplied from the server 13 and data and programs stored in the ROM 102 and the RAM 103.

The pocket position detection circuit 107 includes a proximity sensor and detects the position of the roulette wheel 22 based on the presence or absence of detections of a metal plate mounted to the roulette wheel 22.

The ball throwing device 104 is a device for throwing the ball 27 onto the roulette wheel 22 through the ball throwing port 36 (see FIG. 6). The ball throwing device 104 throws the ball 27 at an initial speed defined by the control data. Further, the ball throwing device 104 throws the ball 27 at timing based on a launching delay time defined by the control data. Namely, the ball throwing device 104 throws the ball 27 after the elapse of the launching delay time since the pocket position detection circuit 107 detected a predetermined number pocket 23 (for example, “00”) passing a predetermined position (for example, the position at the front of the ball throwing port 36).

The ball sensor 105 is a device for determining which number pocket 23 the ball 27 has been housed in.

The wheel driving motor 106 is for rotating the roulette wheel 22 and stops the driving of the motor after the elapse of a motor driving time defied by the control data since the start of the driving thereof.

The ball collecting device 108 is a device for collecting the ball 27 thrown onto the roulette wheel 22 after the end of games.

FIG. 15 is a block diagram illustrating the internal structure of a station according to the first embodiment. Further, the twelve installed stations 4 have basically the same structure and, therefore, a single station 4 will be exemplarily described, hereinafter.

As illustrated in FIG. 15, the station 4 includes a station control portion 90 constituted by a station-controlling CPU 91, a ROM 92 and a RAM 93. The ROM 92 is constituted by, for example, a semiconductor memory or the like and stores programs for realizing basic functions of the station 4, other programs of various types necessary for controlling the station 4, data tables and the like. Further, the RAM 93 is a memory for temporarily storing various types of data resulted from calculations by the station-controlling CPU 91, the number of credits currently possessed by the player (accumulated in the station 4), the condition of betting of chips by the player, and the like.

The station control portion 90 corresponds to the controller in the present invention.

Further, a BET confirmation button 47, a payback button 48 and a help button 49, which are provided in a control portion 7 (see FIG. 5), are connected to the station-controlling CPU 91.

The BET confirmation button 47 is to be pushed for confirming betting after betting operations through the image display device 8.

The payback button 48 is to be generally pushed at the end of games. When the payback button 48 is pushed, the number of medals corresponding to the credits acquired in games and the like and currently possessed by the player (a single medal for a single credit, in general) are paid out from the medal payout port 9.

The help button 49 is to be pushed when the game operating method or the like is unknown. Immediately after the help button 49 is pushed, a help screen describing information on various types of operations is displayed to the image display device 8.

The station-controlling CPU 91, based on operation signals issued by pushing respective buttons and the like, controls the station 4 for conducting various types of operations corresponding to the operation signals. More specifically, the station-controlling CPU 91 conducts various types of processing, based on input signals that the control portion 7 supplies thereto on receiving inputs of operations by the player, and data and programs stored in the ROM 92 and the RAM 93. Then, the station-controlling CPU 91 transmits the result of such processing to the server-controlling CPU 81.

Further, the station-controlling CPU 91, on receiving command signals from the server-controlling CPU 81, controls its peripheral devices constituting the station 4 for processing games in the station 4. Further, the station-controlling CPU 91 conducts various types of processing, based on input signals that the control portion 7 supplies thereto on receiving inputs of operations by the player, and data and programs stored in the ROM 92 and the RAM 93, and then controls its peripheral devices constituting the station 4 for processing games in the station 4, based on the result of such processing, depending on the contents of processing.

Further, a hopper 94 is connected to the station-controlling CPU 91. The hopper 94 pays out predetermined numbers of medals from the medal payout port 9 (see FIG. 5), according to command signals from the station-controlling CPU 91.

Further, the image display device 8 is connected to the station-controlling CPU 91 through a liquid crystal driving circuit 95. The liquid crystal driving circuit 95 includes a program ROM, an image ROM, an image-controlling CPU, a work RAM, a VDP (Video Display Processor) and a video RAM. The program ROM stores image-controlling programs relating to the display within the image display device 8, and various types of selection tables. The image ROM stores, for example, dot data for use in forming images to be displayed to the image display device 8. The image-controlling CPU is for determining images to be displayed to the image display device 8, out of the dot data pre-stored in the image ROM, according to the image-controlling programs pre-stored in the program ROM, based on parameters set in the station-controlling CPU 91. The work RAM is formed as a temporal storage device for use in executing the image-controlling programs with the image-controlling CPU. The VDP creates images corresponding to the content of display determined by the image-controlling CPU and outputs them to the image display device 8. Further, the video RAM is formed as a temporal storage device for use in creating images with the VDP.

Further, the touch panel 50 is provided in the front surface of the image display device 8 as previously described, and information on operations on the touch panel 50 is transmitted to the station-controlling CPU 91. On the touch panel 50, the player performs operations for betting chips through the BET screen 61 and the sub BET screen 62. More specifically, the touch panel 50 is operated in selecting BET areas 72, operating the unit BET buttons 66 and the like, and information on such operations is transmitted to the station-controlling CPU 91. Then, based on such information, information on the betting by the current player is stored in the RAM 93 anytime. Further, the betting information is transmitted to the server-controlling CPU 81 and is stored in the BET information storage area of the RAM 83.

The touch panel 50 corresponds to the main BET button and the sub BET button in the present invention.

Further, a sound output circuit 96 and a speaker 10 are connected to the station-controlling CPU 91, wherein the speaker 10 generates various types of effect sounds when various types of effects are conducted based on output signals from the sound output circuit 96.

Further, a medal sensor 97 is connected to the station-controlling CPU 91. The medal sensor 97 detects medals inserted from a medal insertion port 6 (see FIG. 5), calculates the value of the inserted medals and transmits the result to the station-controlling CPU 91. The station-controlling CPU 91, based on the transmitted signals, increases the number of credits possessed by the player which is stored in the RAM 93.

The WIN lamp 11 is connected to the station-controlling CPU 91. The station-controlling CPU 91 lights the WIN lamp 11 in predetermined colors, in the event of the occurrence of winning relating to chips betted on the BET screen 61 or the winning of JP.

FIG. 16 is a schematic view illustrating a storage area of a ROM in a station according to the first embodiment.

As illustrated in FIG. 16, the ROM 92 included in a station 4 is provided with the arrangement data storage area 92A for storing the arrangement data indicating the sequence of all the number pockets 23 on the roulette wheel 22.

The arrangement data indicates the correspondence between numbers, which are associated with the respective number pockets 23 on the roulette wheel, and numbers, each associated with a number pocket 23 on each side of each of the number pockets 23. For example, the number pocket 23 of “9” is corresponded to the number pocket 23 of “28” on the left side and to the number pocket 23 of “26” on the right side (see FIG. 6).

It is to be noted that if a roulette wheel different from the roulette wheel 22 illustrated in FIG. 6 is used, arrangement data corresponding to the sequence of pockets on that roulette wheel needs to be stored.

The ROM 92 corresponds to the arrangement data storage memory in the present invention.

Next, processing executed in the roulette game machine 1 of the present embodiment will be described. However, since the game processing conducted in the server 13 and the stations 4 has been already described by using FIG. 1 and FIG. 2, detailed descriptions thereof are omitted here, and sub BET reception processing executed in step S16 in FIG. 1 will be described.

FIG. 17 is a flowchart illustrating sub BET reception processing according to the first embodiment.

In the sub BET reception processing, the sub BET screen 62 as illustrated in FIG. 8 to FIG. 10 is displayed to the image display device 8 to receive a sub BET in an event that the BET placed during the BET reception period is a straight BET.

First, in step S401, the station-controlling CPU 91 included in the station 4 determines whether or not a BET has been inputted via the touch panel 50.

If it is determined that the BET has not been inputted, the present subroutine is terminated.

On the other hand, if it is determined that the BET has been inputted, the station-controlling CPU 91 determines, in step S402, whether or not the inputted BET is a straight BET. If the station-controlling CPU 91 determines that the inputted BET is not a straight BET, the station controlling CPU 91 terminates the present subroutine.

Meanwhile, if the station-controlling CPU 91 determines that the inputted BET is a straight BET, the station-controlling CPU 91 displays, in step S403, the sub BET screen 62 to the image display device 8 included in the station 4 (see FIG. 8).

Next, in step S404, the station-controlling CPU 91 conducts the processing of receiving an input of the sub BET.

More specifically, as described by using FIG. 8 to FIG. 10, the station-controlling CPU 91 prompts the player to select whether or not to place a sub BET, by the sub BET screen 62. Then, if the input of placing a sub BET has been entered via the touch panel 50, the station-controlling CPU 91 requests the user to select the range covering the number pockets 23 on which the sub BET is to be placed (in the present embodiment, it is up to a number pocket 23 on both sides of the number pocket 23 on which the straight BET has been placed, or up to the further adjacent number pocket 23 of these respective number pockets 23). Upon selection of the sub BET range, the station-controlling CPU 91 determines the number pockets 23 within the range, based on the number of the number pocket 23 with the straight BET placed thereon and the arrangement data stored in the ROM 92. Then, after the number of BETs has been inputted, the station-controlling CPU 91 temporarily stores information about the number of the number pocket 23 with the sub BET placed thereon and the number of BETs thereof, thereby completing reception of the sub BET.

As described above, the roulette game machine 1 according to the first embodiment comprises the circular roulette wheel 22; the plurality of number pockets 23 arranged adjacent to one another in a line in a circumferential direction on the roulette wheel 22, each of the number pockets 23 associated with a number in advance; the ROM 92 for storing arrangement data indicating a sequence of the plurality of the number pockets 23 on the roulette wheel 22; the touch panel 50 for inputting a BET on a number associated with a single number pocket 23 out of the plurality of the number pockets 23, and for inputting a BET on a number associated with an adjacent pocket adjacent to the single number pocket 23, or on numbers associated with a plurality of the respective number pockets 23 arranged adjacent to one another including the adjacent pocket; and the controller (the server-controlling CPU 81, the ROM 82, the RAM 83, the control portion 109, and the station-controlling portion 90). The controller is programmed to conduct the processing of (a) receiving a BET on a number associated with a single number pocket 23 out of the plurality of the number pockets 23, based on an input from the touch panel 50, (b) receiving, based on an input from the touch panel 50 and the arrangement data stored in the ROM 92, a BET on a number associated with an adjacent pocket adjacent to the single number pocket 23, or on numbers associated with a plurality of the respective number pockets 23 arranged adjacent to one another including the adjacent pocket, (c) controlling rotation of the roulette wheel 22 and launching of the ball 27 to be housed in any one of the number pockets 23, (d) determining a number associated with one of the number pockets 23 with the ball 27 housed therein as a winning number, and (e) providing an award, based on the winning number determined in the processing (d) and the BETs respectively inputted from the touch panel 50.

Therefore, the player can place, by operating the touch panel 50, a BET on the number associated with the number pocket 23 into which the ball 27 is predicted to be housed, and on the numbers associated with the number pockets 23 near the predicted number pocket 23, such as a number pocket 23 adjacent to the predicted number pocket 23 and a number pocket 23 next to the adjacent number pocket 23. In the above-mentioned roulette game machine 1, since a BET on the numbers associated with the number pockets 23 near the predicted number pocket 23 is received based on the arrangement data, the player is not required to memorize the sequence of the numbers associated with the number pockets 23 on the roulette wheel 22. Thus, the player can easily place a BET on the numbers associated with the number pockets 23 near the predicted number pocket 23. As a result, it becomes easier for the player to place a BET such that the player can receive an award even when the ball 27 does not land in the predicted number pocket 23 but in a number pocket 23 nearby.

Further, the controller included in the roulette game machine 1 according to the first embodiment conducts the processing of receiving, based on an input from the touch panel 50 and the arrangement data stored in the ROM 92, a BET on a number associated with an adjacent pocket adjacent to the single number pocket 23, or on numbers associated with a plurality of the respective number pockets 23 arranged adjacent to one another including the adjacent pocket.

Accordingly, the player can place a BET on the numbers associated with number pockets 23 on both right and left sides of the predicted number pocket 23, such as a number pocket 23 on both sides. In the above-mentioned roulette game machine 1, since the BET on the numbers each associated with a number pocket 23 on both right and left sides of the predicted number pocket 23 is received based on the arrangement data, the player is not required to memorize the sequence of the numbers associated with the number pockets 23 on the roulette wheel 22. Therefore, placing a BET on the numbers each associated with the number pocket 23 on both right and left sides of the predicted number pocket 23 is facilitated. As a result, it becomes easier for the player to place a BET such that the player can receive an award even when the ball 27 does not land in the predicted number pocket 23 but in a nearby number pocket 23 on either the right or left side.

### Second Embodiment

In the second embodiment, same numerals are given to the constituents corresponding to those of the roulette game machine according to the first embodiment.

As described above, the second embodiment is different from the first embodiment in that the roulette game machine 1 is controlled, by the control data stored in the ROM 102, so as to provide different weights on probabilities that the ball 27 is housed in each of the number pockets 23 on the roulette wheel 22 (to provide a relatively high weight on a probability that the ball 27 is housed in particular number pockets 23).

Since the external views and the internal structures of the roulette game machine 1, the roulette device 3, and the stations 4 in the present embodiment are substantially the same as those already described in the first embodiment, only the points different from the first embodiment will be described here.

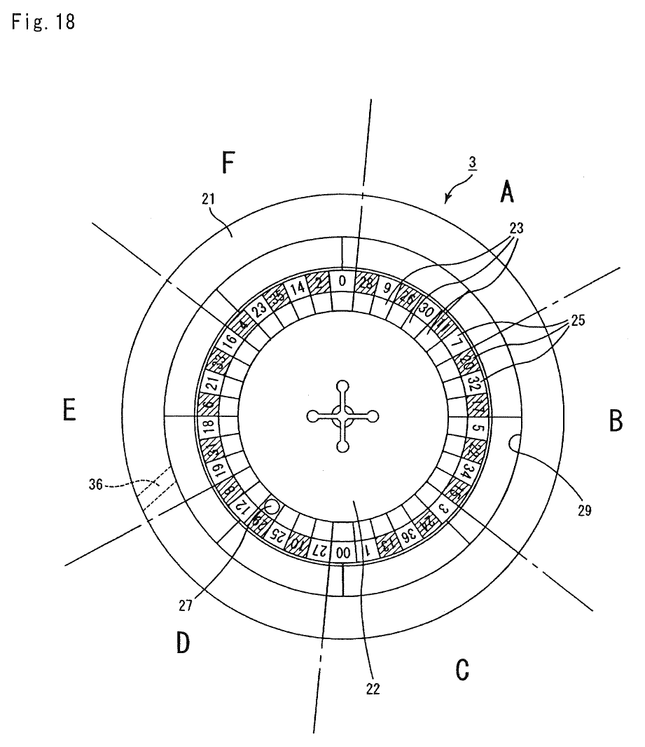

FIG. 18 is a plan view of a roulette device according to the second embodiment.

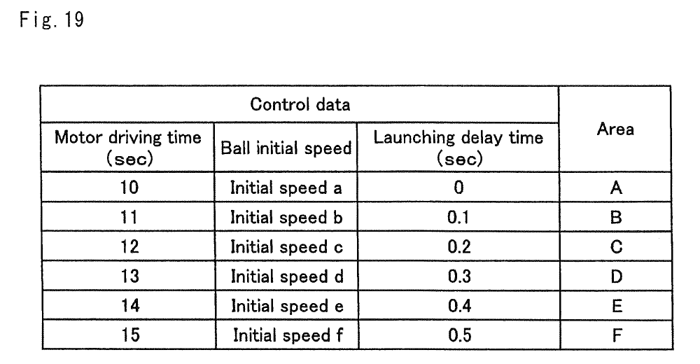

In the present embodiment, rotation of the roulette wheel 22 and launching of the ball 27 are performed based on control data. FIG. 19 is a view illustrating exemplary control data according to the second embodiment.

As illustrated in FIG. 19, the control data includes motor driving time, ball initial speed, and launching delay time.

The motor driving time is for driving the wheel driving motor 106. The roulette wheel 22 is rotated at a predetermined rotation speed by the wheel-driving motor 106 for a length of time corresponding to a motor driving time. Further, after the roulette wheel 22 is released from the driving by the wheel-driving motor 106, the rotation speed of the roulette wheel 22 gradually decreases and the roulette wheel 22 finally stops. Further, the ball initial speed is an initial speed for throwing the ball 27 from the ball throwing device 104. The launching delay time is a time since a predetermined number pocket 23 passes through a predetermined position until a ball is launched, during the rotation of the roulette wheel 22.

As illustrated in FIG. 18, the roulette wheel 22 is divided into 6 areas, which are areas A to F. Each area is constituted by 6 or 7 number pockets 23 adjacent to one another.

The respective control data are determined so as to provide a higher weight on the probability that the ball 27 is housed in one of the areas A to F. For example, when the rotation of the roulette wheel 22 and the launching of the ball 27 are controlled based on the control data “a motor driving time of 10 sec, a ball initial speed a and a launching delay time of 0,” the respective control data are determined so as to provide a higher weight on the probability that the ball 27 is housed in the area A.

In the present embodiment, the roulette wheel 22 rotates counterclockwise, and the ball 27 moves clockwise. For example, when the ball initial speed and launching delay time are fixed, as the motor driving time is made longer, an area with a high probability of housing the ball 27 (hereinafter also referred to as a high probability area) is changed in the following order: A→B→C→D→E→F→A and so forth.

Further, for example, when the motor driving time and the launching delay time are fixed, as the ball initial speed is made higher, the high probability area is changed in the following order: A→B→C→D→E→F→A and so forth.

Moreover, for example, when the motor driving time and the ball initial speed are fixed, as the launching delay time is made longer, the high probability area is changed in the following order: A→B→C→D→E→F→A and so forth.

Accordingly, in the present invention, when the control data includes any combination of data on wheel rotation control (motor driving time), data on timing for launching the ball (launching delay time), and data on the initial speed of the ball being launched (ball initial speed), a plurality of control data different in high probability area can be set, thereby to provide different weights on the probability of each number pocket 23 housing the ball 27.

Further, in the present embodiment, when the initial speed is changed from an initial speed “a” to an initial speed “b”, from the initial speed “b” to an initial speed “c”, from the initial speed “c” to an initial speed “d” and so forth, the high probability area is shifted by one area (e.g., the area is shifted from the area A to the area B). Further, every time the launching delay time is made longer by 0.1 second, the high probability area is shifted by one area. Moreover, every time the motor driving time is made longer by 1 second, the high probability area is shifted by five areas. Therefore, by combination of these, it is possible to set a plurality of control data different in high probability areas, so as to provide different weights on the probability of the each number pocket 23 housing the ball 27.

As in the present embodiment, when the control data is data including the combination of the data on wheel rotation control (motor driving time), the data on timing for launching the ball (launching delay time), and the data on the initial speed of the ball being launched (ball initial speed), apparent variations with respect to the player (e.g., the rotating time of the roulette wheel 22 is long, the initial speed of the ball 27 is high) can be involved.

Friction at the rotational axial section of the roulette wheel 22, the surface shape of the roulette wheel 22 (e.g., depression or distortion), and the like may vary among the roulette game machines 1 due to a variety of factors in manufacturing thereof. Hence there is a case where, even when common control data is used in each of the roulette game machines 1, the areas where the ball 27 is finally housed vary among the roulette game machines 1. Therefore, the control data may be set such that, for example, after completion of the manufacturing, tests are conducted with a variety of parameters included in the control data being changed as appropriate, to organize statistics concerning which parameter may allow which area to have a high probability of housing the ball 27. Namely, the control data may vary among the roulette game machines 1.

Moreover, even when the areas that finally house the ball 27 vary among the roulette game machines 1, the common control data may be used in each of the roulette game machines 1. This is because the probability of housing the ball in some area should just be relatively high based on the control data in each of the roulette game machines 1.

The control data to be the reference target is switched every time the predetermined time (e.g., the 0th minute of every hour) comes. In the present embodiment, a case is described where the control data is switched every time the predetermined time comes. However, the predetermined condition for switching the control data to be referred is not limited to this, and examples thereof may include: the ball being housed in the same pocket for a predetermined number of times in succession; the ball being housed in any of the pockets belonging to the same group (area) for a predetermined number of times in succession; a predetermined bonus (e.g., a mystery bonus and a jackpot) being generated; the currency value betted on any of the numbers belonging to a predetermined group (e.g., a group with a high probability that the ball is housed) reaching a predetermined amount; and the currency value paid out as a result of betting on numbers belonging to a predetermined group (e.g., a group with a high probability that the ball is housed) reaching a predetermined amount.

While, in the example, there has been described a case where the areas A to F are constituted by 6 or 7 number pockets 23 adjacent to one another, there is no particular limitation on the number of pockets belonging to a single group, in the present invention. Further, the respective groups can be constituted by the same number of pockets or different numbers of pockets.

Further, while, in the example, there has been described a case where the number pockets 23 are divided into the 6 areas (groups), which are the areas A to F, the number of areas (groups) is not limited to 6 in the present invention.

In the example, there has been described a case where the areas A to F are not overlapped with one another. Namely, there has been described a case where the pockets belonging to a single group do not belong to the other groups. However, the present invention is not limited thereto, and a single pocket can belong to a plurality of groups.

While, in the example, there has been described a case where a plurality of control data are provided in association with the respective areas (groups), it is necessary only that a plurality of control data are provided, but it is not necessary that they are associated with the respective areas (groups), in the present invention.

While, in the example, there has been described a case where the control data is constituted by motor driving time, ball initial speeds and launching delay time, the control data of the present invention is not limited thereto, but may be data including one of data relating to wheel rotation control (motor driving time), data relating to a timing of ball launching (launching delay time), and data relating to an initial speed for launching a ball (ball initial speeds), or a combination thereof.

Such data relating to wheel rotation control may be, for example, rotation speeds of the roulette wheel when it is driven by the motor, as well as motor driving time.

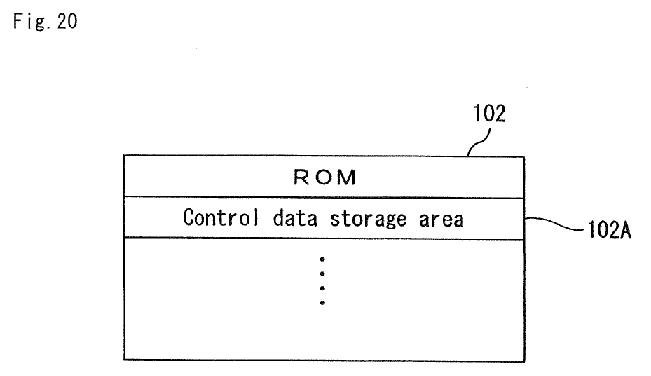

FIG. 20 is a schematic view illustrating a storage area of a ROM in a roulette device according to the second embodiment. As illustrated in FIG. 20, the ROM 102 included in the roulette device 3 is provided with the control data storage area 102A in which the control data having a structure described by using FIG. 19 is stored.

The ROM 102 corresponds to the control data storage memory in the present invention.

The game processing conducted in the server 13 and the stations 4 in the roulette game machine 1 has been described by using FIG. 3 and FIG. 4. Further, since the details of the sub BET reception processing are similar to those having been described in the first embodiment, descriptions thereof will be omitted here. Moreover, since the images displayed to the image display device 8 during the BET reception period are also similar to those having been described by using FIG. 7 to FIG. 10 in the first embodiment, descriptions thereof will be omitted here.

As described above, the roulette game machine 1 according to the second embodiment comprises: the circular roulette wheel 22; the plurality of number pockets 23 arranged adjacent to one another in a line in a circumferential direction on the roulette wheel 22, each of the number pockets 23 associated with a number in advance; the ROM 92 for storing arrangement data indicating a sequence of the plurality of the number pockets 23 on the roulette wheel 22; the ROM 102 for storing control data for controlling the roulette game machine 1 so as to provide different weights on probabilities that the ball 27 is housed in each of the number pockets 23; the touch panel 50 for inputting a BET on a number associated with a single number pocket 23 out of the plurality of the number pockets 23, and for inputting a BET on a number associated with an adjacent pocket adjacent to the single number pocket 23, or on numbers associated with a plurality of the respective number pockets 23 arranged adjacent to one another including the adjacent pocket; and the controller (the server-controlling CPU 81, the ROM 82, the RAM 83, the control portion 109, and the station control portion 90). The controller is programmed to conduct the processing of (a) receiving a BET on a number associated with a single number pocket 23 out of the plurality of the number pockets 23, based on an input from the touch panel 50, (b) receiving, based on an input from the touch panel 50 and the arrangement data stored in the ROM 92, a BET on a number associated with an adjacent pocket adjacent to the single number pocket 23, or on numbers associated with a plurality of the respective number pockets 23 arranged adjacent to one another including the adjacent pocket, (c) controlling, based on the control data stored in the ROM 102, rotation of the roulette wheel 22 and launching of the ball 27, (d) determining a number associated with one of the number pockets 23 with the ball 27 housed therein as a winning number, and (e) providing an award, based on the winning number determined in the processing (d) and the BETs respectively inputted from the touch panel 50.

Therefore, the player can place, by operating the touch panel 50, a BET on the number associated with the number pocket 23 into which the ball 27 is predicted to be housed, and on the numbers associated with the number pockets 23 near the predicted number pocket 23, such as a number pocket 23 adjacent to the predicted number pocket 23 and a number pocket 23 next to the adjacent number pocket 23. In the above-mentioned roulette game machine 1, since a BET on the numbers associated with the number pockets 23 near the predicted number pocket 23 is received based on the arrangement data, the player is not required to memorize the sequence of the numbers associated with the number pockets 23 on the roulette wheel 22. Thus, the player can easily place a BET on the numbers associated with the number pockets 23 near the predicted number pocket 23. As a result, it becomes easier for the player to place a BET such that the player can receive an award even when the ball 27 does not land in the predicted number pocket 23 but in a number pocket 23 nearby.

Further, although it is preferred that a ball drops in each of the pockets so as to be housed therein with the same probability in a roulette apparatus, the probabilities that the ball is housed in each of the pockets tend to be biased due to a variety of factors in manufacturing thereof. On the contrary, since the above-mentioned roulette game machine 1 is controlled with use of the control data so as to provide different weights on the probabilities that the ball is housed, an administrator of the roulette game machine 1 (e.g., a manager of the casino) can prevent, by appropriately changing the control data, heavy losses due to players detecting the bias. Meanwhile, since the player can easily place a BET on the neighboring number pockets 23 of the predicted number pocket 23 even though detecting the bias of probabilities is difficult, it becomes easier for the player to place a BET such that the player can receive an award even when the prediction has been wrong.

Further, the controller included in the roulette game machine 1 according to the second embodiment conducts the processing of receiving, based on an input from the touch panel 50 and the arrangement data stored in the ROM 92, a BET on a number associated with an adjacent pocket adjacent to the single number pocket 23, or on numbers associated with a plurality of the respective number pockets 23 arranged adjacent to one another including the adjacent pocket.

Accordingly, the player can place a BET on the numbers associated with number pockets 23 on both right and left sides of the predicted number pocket 23, such as a number pocket 23 on both sides. In the above-mentioned roulette game machine 1, since the BET on the numbers each associated with a number pocket 23 on both right and left sides of the predicted number pocket 23 is received based on the arrangement data, the player is not required to memorize the sequence of the numbers associated with the number pockets 23 on the roulette wheel 22. Therefore, placing a BET on the numbers each associated with the number pocket 23 on both right and left sides of the predicted number pocket 23 is facilitated. As a result, it becomes easier for the player to place a BET such that the player can receive an award even when the ball 27 does not land in the predicted number pocket 23 but in a nearby number pocket 23 on either the right or left side.

In the first embodiment and the second embodiment, a case has been described where the main BET button and the sub BET button in the present invention are the same device (touch panel 50). However, in the present invention, the main BET button and the sub BET button may be separately provided devices.

Further, the main BET button and the sub BET button in the present invention may be a physical button (e.g., push buttons installed in the station).

In the first embodiment and the second embodiment, a case has been described where the player can decide the number of BETs on a number pocket 23 on both sides of the number pocket 23 on which the straight BET has been placed (namely, the number of BETs for the sub BET). However, the present invention is not limited to this example. For example, the number of BETs for the sub BET may be previously determined, or may be determined according to the number of BETs for the straight BET by the player. In the case where the number of BETs for the sub BET is previously determined or determined according to the number of BETs for the straight BET by the player, the game machine may be configured so as to vary the number of BETs according to the position of the pocket (e.g., on both sides of the pocket on which the straight BET has been placed, or the next pocket of these pockets) on which the sub BET is to be placed.

Moreover, in the first embodiment and the second embodiment, the case has been described where a sub BET can be placed on the same number of number pockets 23 on the right and left sides of the number pocket 23 on which a straight BET has been placed. However, in the present invention, a sub BET may be placed on the respectively different numbers of pockets on the right and left sides of a single pocket on which the straight BET has been placed.

Furthermore, in the first embodiment and the second embodiment, a configuration has been described where the player selects whether or not to place a sub BET on the number pocket 23 on both sides of the single number pocket 23 on which the straight BET has been placed. However, in the present invention, the game machine may be configured so as to always have the player to place a sub BET, in the event that a straight BET has been placed, on the pocket on both sides of the pocket on which the straight BET has been placed. In such a configuration, in the event that the straight BET has been placed, an image may be displayed to the image display device, the image notifying the player that a sub BET is to be placed on the pockets on both sides of the pocket on which the straight BET has been placed.

Although the present invention has been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processes to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A game apparatus comprising:
a circular roulette wheel;
a plurality of pockets arranged adjacent to one another in a line in a circumferential direction on said roulette wheel, each of said pockets associated with a number in advance;
an arrangement data storage memory for storing arrangement data indicating a sequence of the plurality of said pockets on said roulette wheel;
a main BET button for inputting a BET on a number associated with a single pocket out of the plurality of said pockets;
a sub BET button for inputting a BET on a number associated with an adjacent pocket adjacent to said single pocket, or on numbers associated with a plurality of said respective pockets arranged adjacent to one another including said adjacent pocket; and
a controller,
said controller programmed to conduct the processing of
(a) receiving a BET on a number associated with a single pocket out of the plurality of said pockets, based on an input from said main BET button,
(b) receiving, based on an input from said sub BET button and the arrangement data stored in said arrangement data storage memory, a BET on a number associated with an adjacent pocket adjacent to said single pocket, or on numbers associated with a plurality of said respective pockets arranged adjacent to one another including said adjacent pocket,
(c) controlling rotation of said roulette wheel and launching of a ball to be housed in any one of said pockets,
(d) determining a number associated with one of said pockets with said ball housed therein as a winning number, and
(e) providing an award, based on the winning number determined in said processing (d) and the BETs respectively inputted from said main BET button and said sub BET button.

2. The game apparatus according to claim 1,
wherein
said processing (b) includes
receiving, based on an input from said sub BET button and the arrangement data stored in said arrangement data storage memory, a BET on numbers each associated with an adjacent pocket adjacent on each side to said single pocket, or on numbers associated with a plurality of said respective pockets arranged adjacent to one another including said adjacent pockets.

3. A game apparatus comprising:
a circular roulette wheel;
a plurality of pockets arranged adjacent to one another in a line in a circumferential direction on said roulette wheel, each of said pockets associated with a number in advance;
an arrangement data storage memory for storing arrangement data indicating a sequence of the plurality of said pockets on said roulette wheel;
a control data storage memory for storing control data for controlling the game apparatus so as to provide different weights on probabilities that a ball is housed in each of said pockets;
a main BET button for inputting a BET on a number associated with a single pocket out of the plurality of said pockets;
a sub BET button for inputting a BET on a number associated with an adjacent pocket adjacent to said single pocket, or on numbers associated with a plurality of said respective pockets arranged adjacent to one another including said adjacent pocket; and
a controller,
said controller programmed to conduct the processing of
(a) receiving a BET on a number associated with a single pocket out of the plurality of said pockets, based on an input from said main BET button,
(b) receiving, based on an input from said sub BET button and the arrangement data stored in said arrangement data storage memory, a BET on a number associated with an adjacent pocket adjacent to said single pocket, or on numbers associated with a plurality of said respective pockets arranged adjacent to one another including said adjacent pocket,
(c) controlling, based on the control data stored in said control data storage memory, rotation of said roulette wheel and launching of said ball,
(d) determining a number associated with one of said pockets with said ball housed therein as a winning number, and
(e) providing an award, based on the winning number determined in said processing (d) and the BETs respectively inputted from said main BET button and said sub BET button.

4. The game apparatus according to claim 3,
wherein
said processing (b) includes
receiving, based on an input from said sub BET button and the arrangement data stored in said arrangement data storage memory, a BET on numbers each associated with an adjacent pocket adjacent on each side to said single pocket, or on numbers associated with a plurality of said respective pockets arranged adjacent to one another including said adjacent pockets.

5. A control method of a game apparatus that includes a circular roulette wheel; a plurality of pockets arranged adjacent to one another in a line in a circumferential direction on said roulette wheel, each of said pockets associated with a number in advance; an arrangement data storage memory for storing arrangement data indicating a sequence of the plurality of said pockets on said roulette wheel; a main BET button for inputting a BET on a number associated with a single pocket out of the plurality of said pockets; a sub BET button for inputting a BET on a number associated with an adjacent pocket adjacent to said single pocket, or on numbers associated with a plurality of said respective pockets arranged adjacent to one another including said adjacent pocket; and a controller,
said control method of the game apparatus comprising the steps of
(a) receiving a BET on a number associated with a single pocket out of the plurality of said pockets, based on an input from said main BET button,
(b) receiving, based on an input from said sub BET button and the arrangement data stored in said arrangement data storage memory, a BET on a number associated with an adjacent pocket adjacent to said single pocket, or on numbers associated with a plurality of said respective pockets arranged adjacent to one another including said adjacent pocket,
(c) controlling rotation of said roulette wheel and launching of a ball to be housed in any one of said pockets,
(d) determining a number associated with one of said pockets with said ball housed therein as a winning number, and
(e) providing an award, based on the winning number determined in said step (d) and the BETs respectively inputted from said main BET button and said sub BET button.

6. The control method of the game apparatus, according to claim 5,
wherein
said step (b) includes
receiving, based on an input from said sub BET button and the arrangement data stored in said arrangement data storage memory, a BET on numbers each associated with an adjacent pocket adjacent on each side to said single pocket, or on numbers associated with a plurality of said respective pockets arranged adjacent to one another including said adjacent pockets.
